(19) United States
(12) Patent Application Publication
(10) Pub. No.: US 2016/0296915 A1
(43) Pub. Date: Oct. 13, 2016

(54) EXHAUST GAS PURIFICATION CATALYST AND PRODUCTION METHOD THEREOF

(71) Applicant: TOYOTA JIDOSHA KABUSHIKI KAISHA, Toyota-shi, Aichi (JP)

(72) Inventors: Naoto NAGATA, Gotenba-shi (JP); Kimiyasu ONO, Gotenba-shi (JP)

(73) Assignee: Toyota Jidosha Kabushiki Kaisha, Toyota-shi, Aichi (JP)

(21) Appl. No.: 15/038,559

(22) PCT Filed: Oct. 27, 2014
(86) PCT No.: PCT/JP2014/078482

§ 371 Date: May 23, 2016

(30) Foreign Application Priority Data
Nov. 22, 2013 (JP) 2013-241931

(51) Int. Cl. B01J 23/755; B01J 35/00; B01J 35/02; B01D 53/94; B01J 37/04; B01J 37/10; B01J 37/00; B01J 23/10; B01J 35/10

(52) U.S. Cl. CPC B01J 23/755; B01J 23/10; B01J 35/0006; B01J 35/0013; B01J 35/023; B01J 35/1014; B01J 37/04; B01J 37/10; B01J 37/0018; B01D 53/945; B01D 2255/20753; B01D 2255/2065

(57) ABSTRACT

Provided are an exhaust gas purification catalyst comprising a nanocomposite material comprising CeO₂ and NiO which are uniformly mixed; and a production method thereof. The uniform mixing satisfies at least one of following conditions: (a) when the nanocomposite material is analyzed using STEM-EDX, the number of Ni atoms is from 3 to 20 atomic % relative to the total number of Ni and Ce atoms at a majority of randomly selected 5 or more measurement points in which both Ce and Ni elements are detected; and (b) in the Fourier transform of EXAFS spectrum at Ni—K absorption edge regarding the nanocomposite material, the ratio of the peak intensity of Ni—O near an interatomic distance of 1.8 Å to the peak intensity of Ni—Ni near an interatomic distance of 2.6 Å is 1:at least 0.50 to less than 2.18.

### TECHNICAL FIELD

The present invention relates to an exhaust gas purification catalyst and a production method thereof. More specifically, the present invention relates to an exhaust gas purification catalyst comprising nickel as a catalyst component, and a production method thereof.

### BACKGROUND ART

Harmful ingredients such as carbon monoxide (CO), hydrocarbon (HC) and nitrogen oxide (NOx) are contained in an exhaust gas discharged from an automotive internal combustion engine such as a gasoline engine and diesel engine. Therefore, an exhaust gas purification system for decomposing and removing these harmful ingredients is generally provided in a vehicle, and the harmful ingredients are made harmless by an exhaust gas purification catalyst arranged in the exhaust gas purification system. Conventionally, a three-way catalyst capable of simultaneously performing oxidation of CO and HC and reduction of NOx in the exhaust gas has been used as the exhaust gas purification catalyst. More specifically, a catalyst obtained by supporting a noble metal, in particular a platinum group element such as platinum (Pt), rhodium (Rh) and palladium (Pd) on a porous oxide support such as alumina (Al₂O₃) is widely known as a three-way catalyst.

However, such a platinum group element is a very expensive rare metal, because it is produced in a small area and the production is concentrated in specific areas such as South Africa and Russia. In addition, the platinum group element is being used in increasingly larger amounts along with toughening of automotive emission controls. For this reason, depletion of resources is becoming a concern. Therefore, it is required to reduce the amount of use of the platinum group element and, in the future, to replace the platinum group element in role with other metals, etc. Thus, many studies are being made on a catalyst component to reduce the amount of use of the platinum group element or substitute for the platinum group element.

Patent Document 1 describes an NOx purifying catalyst comprising a catalyst support and Au and Fe supported thereon, wherein Au and Fe are present in a state of at least partially adjoining each other. In addition, Patent Document 1 describes a production method of the NOx purifying catalyst comprising adding a reducing agent such as sodium borohydride to a solution containing an Au salt, an Fe salt, and a protecting agent such as polyvinylpyrrolidone (PVP) to reduce Au ions and Fe ions contained in the solution, and supporting the obtained metal particle composed of Au and Fe on a catalyst support powder. Patent Document 2, etc., also describe use of an NOx purifying catalyst comprising a combination of Au and Fe.

Meanwhile, the activity or selectivity of a supported catalyst such as exhaust gas purification catalyst is sometimes dramatically enhanced by adding second and third components to an active site of the supported catalyst.

For example, Patent Document 3 describes a composite oxide comprising oxygen; R consisting of at least one element selected from Ce and Pr; Zr; and M consisting of at least one element selected from alkaline earth metals, rare earth elements other than R, transition metal elements other than rare earth elements and Zr, halogen elements, B, C, Si, and S; wherein a content of R is not less than 10 at % and not more than 90 at %, a content of Zr is not less than 10 at % and less than 90 at %, and a content of M is more than 0 at % and not more than 20 at %, with a total amount of elements other than oxygen being 100 at %, wherein the composite oxide is free of a tetragonal crystal phase originated from zirconium oxide, and wherein an electron diffraction pattern of the composite oxide appears as dotted diffraction spots. In addition, Patent Document 3 describes that the composite oxide preferably contains Ni, etc., as M, because the amount of oxygen absorption and desorption increases.

Patent Document 4 describes a bifunctional catalyst containing multimetal oxides characterized in that 3-30 wt. % metal oxides based on the catalyst is deposited as active components upon the outer and/or inner surface of a support of a moulded mixture of silica and alumina in the weight ratio of 1:1.2-2.5; the metal elements of the metal oxides are at least two selected from transition metals of period 4 of the periodic table of elements and lanthanides; whereas the metal oxides of the catalyst do not exist in a state of composite oxides. In addition, Patent Document 4 describes that the metal oxides are selected from the group consisting of chromium oxide, manganese oxide, iron oxide, copper oxide, cobalt oxide, nickel oxide, zinc oxide, vanadium oxide, titanium oxide, lanthanum oxide and cerium oxide.

### PRIOR ART DOCUMENTS

### Patent Documents

Patent Document 1: JP 2012-163059 A

Patent Document 2: JP 2011-98265 A

Patent Document 3: WO 2009/101984 A1

Patent Document 4: JP H9-501601 A

### SUMMARY OF THE INVENTION

### Problems to be Solved by the Invention

Some metals, in particular some base metals, other than Fe (iron), etc., described in Patent Document 1 have also been proposed as the catalyst component capable of substituting for the platinum group element in other documents, etc. However, generally, a base metal such as iron is known to be easily oxidized compared with the platinum group element. For this reason, even if such a base metal is used as a catalyst component for the exhaust gas purification catalyst, the base metal is relatively easily oxidized by an oxidizing component such as oxygen contained in the exhaust gas. In this case, since metalation of the base metal is poor, sufficient catalytic activity cannot be achieved for the exhaust gas purification, and in particular the reduction purification of NOx.

Accordingly, in order to achieve a high catalytic activity for the exhaust gas purification by maintaining a base metal not in an oxide state, but in a metal state, it is typically necessary to control the air-fuel ratio of the exhaust gas to, for example, an air-fuel ratio sufficiently richer than the theoretical air-fuel ratio (stoichiometric ratio). However, driving in such a fuel-rich atmosphere incurs a significant reduction in the fuel economy, and therefore is generally not preferable.

In the present invention, studies have been made by focusing attention particularly on Ni (nickel), among various base metals, as a catalyst component substituting for the platinum group element. Accordingly, an object of the present invention is to provide a novel exhaust gas purification catalyst comprising nickel as a catalyst component, in which the exhaust gas purification activity, in particular the NOx reduction activity is improved; and a production method thereof.

### Means for Solving the Problems

The present invention for attaining this object is as follows.

(1) An exhaust gas purification catalyst, comprising a nanocomposite material comprising ceria and nickel oxide, wherein the ceria and nickel oxide are uniformly mixed, and wherein the uniform mixing satisfies at least one of following conditions (a) and (b):

(a) when the nanocomposite material is analyzed using a scanning transmission electron microscope equipped with an energy dispersive X-ray analyzer (STEM-EDX) under condition in which the spot size of an electron beam is 1 nm or less, the number of nickel atoms is from 3 to 20 atomic % relative to the total number of nickel and cerium atoms at a majority of randomly selected 5 or more measurement points in which both cerium and nickel elements are detected, and

(b) in the Fourier transform of Extended X-ray Absorption Fine Structure (EXAFS) spectrum at Ni—K absorption edge regarding the nanocomposite material, the ratio of the intensity of a peak attributable to Ni—O near an interatomic distance of 1.8 Å to the intensity of a peak attributable to Ni—Ni near an interatomic distance of 2.6 Å is 1:at least 0.50 to less than 2.18.

(2) The exhaust gas purification catalyst as described in item (1), wherein the uniform mixing at least satisfies the condition (a).

(3) The exhaust gas purification catalyst as described in item (1), wherein the uniform mixing at least satisfies the condition (b).

(4) The exhaust gas purification catalyst as described in any one of items (1) to (3), wherein in the condition (a), the number of nickel atoms is from 3 to 20 atomic % relative to the total number of nickel and cerium atoms at 70% or more of randomly selected 5 or more measurement points in which both cerium and nickel elements are detected.

(5) The exhaust gas purification catalyst as described in any one of items (1) to (4), wherein the number of nickel atoms is from 5 to 15 atomic % relative to the total number of nickel and cerium atoms.

(6) The exhaust gas purification catalyst as described in any one of items (1) to (5), wherein in the condition (b), the intensity ratio of the peaks is 1:at least 1.00 to no more than 2.10.

(7) The exhaust gas purification catalyst as described in any one of items (1) to (6), wherein in the X-ray diffraction with CuKα ray of the nanocomposite material, the height of the diffraction peak around 43.3° attributable to NiO is less than or equal to one-tenth of the height of the diffraction peak around 28.5° attributable to CeO₂.

(8) The exhaust gas purification catalyst as described in item (7), wherein in the X-ray diffraction with CuKα ray of the nanocomposite material, the diffraction peak around 43.3° attributable to NiO is not observed.

(9) The exhaust gas purification catalyst as described in any one of items (1) to (8), wherein the nanocomposite material has a nickel content of greater than 0 mol % to no more than 80 mol % relative to all metal elements contained in the nanocomposite material.

(10) The exhaust gas purification catalyst as described in item (9), wherein the nanocomposite material has a nickel content of at least 9 mol % to no more than 42 mol % relative to all metal elements contained in the nanocomposite material.

(11) The exhaust gas purification catalyst as described in any one of items (1) to (10), wherein the ceria has a crystallite size of greater than 0 nm to no more than 10 nm.

(12) The exhaust gas purification catalyst as described in any one of items (1) to (11), wherein the nanocomposite material has a specific surface area of 90 m²/g or more.

(13) A method for producing an exhaust gas purification catalyst, comprising:

introducing a basic substance into an aqueous solution containing cerium ions, nickel ions and a surfactant,

hydrothermally treating the resulting mixed solution to form a nanocomposite material precursor, and

drying and firing the nanocomposite material precursor.

(14) The method as described in item (13), wherein the hydrothermal treating step is carried out at a temperature of 100 to 150° C.

(15) The method as described in item (13) or (14), wherein the surfactant is selected from the group consisting of an anionic surfactant, a cationic surfactant, an amphoteric surfactant, a nonionic surfactant, and combinations thereof.

(16) The method as described in any one of items (13) to (15), wherein the surfactant is cetyltrimethylammonium bromide.

(17) The method as described in any one of items (13) to (16), wherein the basic substance is selected from the group consisting of sodium hydroxide, potassium hydroxide, ammonia, sodium carbonate, and combinations thereof.

### Effect of the Invention

According to the present invention, uniformly mixing nickel, more specifically nickel oxide (NiO) with ceria (CeO₂) at the nano-level, i.e., uniformly compositing them at the nano-level makes it possible to obtain an exhaust gas purification catalyst comprising a nanocomposite material having a remarkably improved exhaust gas purification activity, especially NOx reduction activity, compared with a material obtained merely by impregnation supporting of nickel on ceria or a nickel oxide-ceria composite material prepared by a conventionally known coprecipitation method, etc. Further, according to such an exhaust gas purification catalyst, even in an oxygen-containing atmosphere generally disadvantageous to a base metal, a high NOx reduction activity can be achieved from a relatively low temperature region. Further, according to the exhaust gas purification catalyst of the present invention, NOx in an exhaust gas can be purified by reduction without using a platinum group element such as Pt, Pd and Rh, and therefore the exhaust gas purification catalyst of the present invention is very advantageous compared with a conventional exhaust gas purification catalyst comprising nickel or nickel oxide. In addition, according to the method of the present invention, use of a surfactant can prevent primary particles from fusing with each other at the time of introduction of a basic substance, and therefore it is possible to unfailingly obtain the above-described composite material comprising ceria and nickel oxide which are uniformly mixed.

### BRIEF DESCRIPTION OF THE DRAWINGS

FIG. 1 shows a scanning transmission electron microscope (STEM) image of the exhaust gas purification catalyst of the present invention, and a schematic view of the structure.

FIG. 2 is a conceptual view illustrating the mechanism of NOx purification reaction in the exhaust gas purification catalyst of the present invention.

FIG. 3 is a schematic view illustrating the crystal structure of nickel oxide (NiO).

FIG. 4 shows an X-ray diffraction pattern regarding the exhaust gas purification catalysts of Examples 1 to 4 and Comparative Examples 1, 2, 6 and 7.

FIG. 5 is a schematic view illustrating the crystal structure of ceria (CeO₂).

FIG. 6 shows a photograph of the exhaust gas purification catalyst of Comparative Example 1 by a scanning transmission electron microscope equipped with an energy dispersive X-ray analyzer (STEM-EDX).

FIG. 7 shows the analysis results of the exhaust gas purification catalyst of Example 1 by STEM-EDX.

FIG. 8 shows the analysis results of the exhaust gas purification catalyst of Example 2 by STEM-EDX.

FIG. 9 shows the analysis results of the exhaust gas purification catalyst of Example 3 by STEM-EDX.

FIG. 10 shows the analysis results of the exhaust gas purification catalyst of Comparative Example 6 by STEM-EDX.

FIG. 11 shows the analysis results of the exhaust gas purification catalyst of Comparative Example 7 by STEM-EDX.

FIG. 12(a) shows the NO 50% purification temperature T50 regarding the exhaust gas purification catalysts of Examples 1 to 4 and Comparative Examples 1 to 6 when oxygen is present, and FIG. 12(b) shows the NO 50% purification temperature T50 regarding the exhaust gas purification catalysts of Examples 1 to 4 and Comparative Examples 1 to 6 when oxygen is not present.

FIG. 13 shows the NO purification ratio regarding the exhaust gas purification catalysts of Example 1, Comparative Example 3 (impregnation method) and Comparative Example 6 (coprecipitation method) when oxygen is present.

FIG. 14 shows conversion profiles of NO, CO and O₂ regarding the exhaust gas purification catalyst of Example 2 when oxygen is present.

FIG. 15 shows X-ray photoelectron spectroscopy (XPS) analysis results of the exhaust gas purification catalysts of Examples 1 to 3 and Comparative Examples 1 and 2.

FIG. 16 shows Raman spectroscopy analysis results of the exhaust gas purification catalysts of Examples 1 to 3 and Comparative Example 1.

FIG. 17 shows an XANES spectrum at Ni—K absorption edge regarding the exhaust gas purification catalysts of Examples 1 to 3 and Comparative Example 2.

FIG. 18 shows a radial distribution function obtained by Fourier transforming the EXAFS spectrum at Ni—K absorption edge regarding the exhaust gas purification catalysts of Examples 1 to 3 and Comparative Example 2.

FIG. 19 shows in-situ XAFS analysis results regarding the exhaust gas purification catalysts of Example 1 and Comparative Examples 1 to 3.

### MODE FOR CARRYING OUT THE INVENTION

### <Exhaust Gas Purification Catalyst>

The exhaust gas purification catalyst of the present invention comprises a nanocomposite material comprising ceria and nickel oxide, wherein the ceria and nickel oxide are uniformly mixed, and wherein the uniform mixing satisfies at least one of following conditions (a) and (b):

(a) when the nanocomposite material is analyzed using a scanning transmission electron microscope equipped with an energy dispersive X-ray analyzer (STEM-EDX) under condition in which the spot size of an electron beam is 1 nm or less, the number of nickel atoms is from 3 to 20 atomic % relative to the total number of nickel and cerium atoms at a majority of randomly selected 5 or more measurement points in which both cerium and nickel elements are detected, and

(b) in the Fourier transform of Extended X-ray Absorption Fine Structure (EXAFS) spectrum at Ni—K absorption edge regarding the nanocomposite material, the ratio of the intensity of a peak attributable to Ni—O near an interatomic distance of 1.8 Å to the intensity of a peak attributable to Ni—Ni near an interatomic distance of 2.6 Å is 1:at least 0.50 to less than 2.18.

As described above in connection with iron, there is a problem in that a base metal such as nickel is relatively easily oxidized by, for example, an oxidizing component contained in the exhaust gas, resulting in poor metalation of the base metal, and therefore a sufficient catalytic activity cannot be achieved for the exhaust gas purification, especially the reduction purification of NOx.

This time, the present inventors have found that uniformly mixing nickel, more specifically nickel oxide (NiO) with ceria (CeO₂) at the nano-level, i.e., uniformly compositing them at the nano-level makes it possible to remarkably improve the exhaust gas purification activity, especially NOx reduction activity of the resulting exhaust gas purification catalyst, compared with a material obtained merely by impregnation supporting of nickel on ceria or a nickel oxide-ceria composite material prepared by a conventionally known coprecipitation method, etc. Further, the present inventors have found that according to an exhaust gas purification catalyst in which nickel oxide and ceria are uniformly mixed at the nano-level, even in an oxygen-containing atmosphere generally disadvantageous to a base metal such as nickel, a high NOx reduction activity can be achieved from a relatively low temperature region.

As for nickel, its utilization as a co-catalyst component in a catalyst for purifying an exhaust gas from an automobile, etc., has been proposed. However, since nickel is a metal relatively easily oxidized as described above, its applicability as a catalyst component in an exhaust gas purification catalyst is not necessarily recognized in general. Accordingly, it is quite unexpected and surprising that as in the present invention, combining nickel as a catalyst component with ceria to allow them to coexist at the nano-level makes it possible to achieve high activity for reduction of harmful ingredients in the exhaust gas, especially NOx.

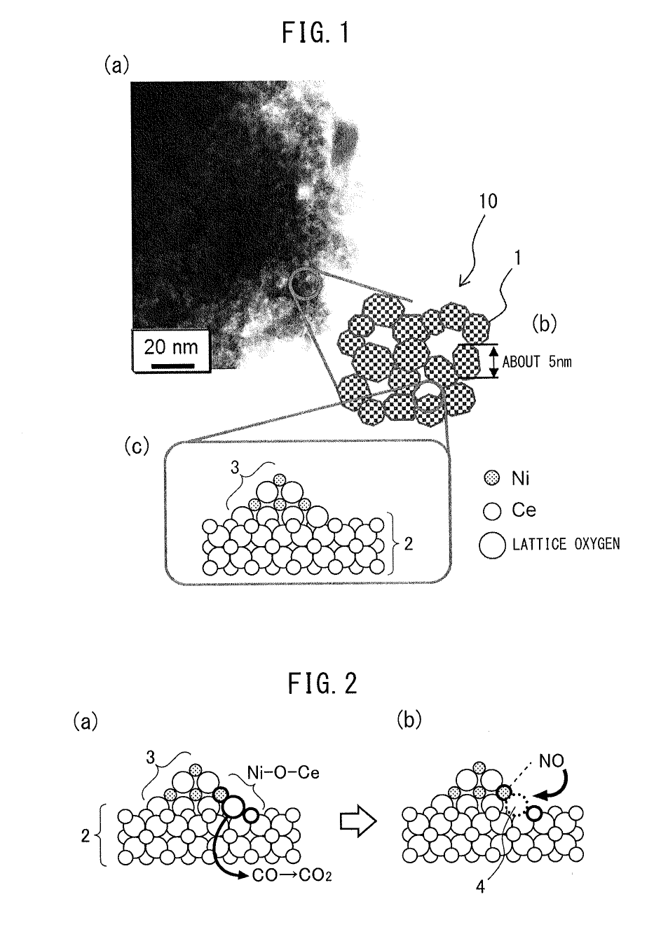

Without being bound by any particular theory, in the exhaust gas purification catalyst of the present invention, NOx purification is considered to proceed, for example, by the below-described reaction mechanism. First, FIG. 1 shows a scanning transmission electron microscope (STEM) image of the exhaust gas purification catalyst of the present invention, and a schematic view of the structure. Referring to the STEM image of FIG. 1(a), it can be seen that in the exhaust gas purification catalyst 10 of the present invention, a primary particle 1 having a particle diameter on the order of several nanometers, especially on the order of about 5 nm is formed. As illustrated in the schematic view of FIG. 1(b) and its enlarged view of FIG. 1(c), this primary particle 1 is believed to have a configuration where fine nickel oxide (NiO) clusters 3 are dispersed on nanoparticles composed of ceria (CeO₂) 2 having a particle diameter of several nanometers.

As illustrated in FIG. 1(c), many nickel oxide-ceria interface structures containing, for example, a bond like Ni—O—Ce are formed in a structure where ceria and nickel oxide are uniformly mixed at the nano-level, i.e., a structure where they are uniformly composited at the nano-level. Since such an interface structure is unstable, as shown in FIG. 2, oxygen in the Ni—O—Ce bond seems to relatively easily desorb and react with a reducing component in the exhaust gas, for example, carbon monoxide (CO) to produce carbon dioxide (CO₂) (FIG. 2(a)). As a result, it is believed that an oxygen hole 4 (or oxygen defect) is formed at the interface between nickel oxide and ceria, NO in the exhaust gas adsorbs to the oxygen hole 4 (FIG. 2(b)) and is decomposed and purified by reduction. According to the exhaust gas purification catalyst of the present invention, since ceria and nickel oxide are uniformly mixed at the nano-level, it is believed that a large number of the above-described oxygen holes are formed at the interface between nickel oxide and ceria. As a result, it is believed that a high NOx reduction activity can be achieved from a relatively low temperature region even in an oxygen-containing atmosphere generally disadvantageous to a base metal such as nickel.

In other words, in the exhaust gas purification catalyst of the present invention having a structure where ceria and nickel oxide are uniformly mixed at the nano-level, as described above, many oxygen holes are formed in the interface portion of nickel oxide and ceria, and in this case nickel in the interface portion is reduced from an oxide state of relatively low activity to a metal state of relatively high activity. That is, according to the exhaust gas purification catalyst of the present invention, a high NOx reduction activity is believed to be achievable from a relatively low temperature region by virtue of such a reduction-accelerating effect of nickel resulting from compositing ceria and nickel oxide, even in an oxygen-containing atmosphere generally disadvantageous to a base metal such as nickel.

### [Judgment of Uniform Mixing by STEM-EDX]

In the exhaust gas purification catalyst of the present invention, the nanocomposite material comprises ceria and nickel oxide which are uniformly mixed, as described above, and more specifically such uniform mixing can be determined by the fact that when the nanocomposite material is analyzed using a scanning transmission electron microscope equipped with an energy dispersive X-ray analyzer (STEM-EDX: Scanning Transmission Electron Microscope-Energy Dispersive X-ray Analysis) under condition in which the spot size of an electron beam is 1 nm or less, the number of nickel atoms is from 3 to 20 atomic % relative to the total number of nickel and cerium atoms at a majority of randomly selected 5 or more measurement points in which both cerium and nickel elements are detected.

STEM-EDX is an analyzer fabricated by combining a scanning transmission electron microscope (STEM) and an energy dispersive X-ray analyzer (EDX), and elemental analysis in a specific portion or region of an STEM image can be carried out by using this analyzer.

According to the present invention, when the nanocomposite material is analyzed using STEM-EDX under condition in which the spot size of an electron beam is 1 nm or less, for example, if the number of nickel atoms is from 3 to 20 atomic % relative to the total number of nickel and cerium atoms only at one or two measurement points for randomly selected 5 measurement points in which both cerium and nickel elements are detected, or if the number of nickel atoms is not from 3 to 20 atomic % relative to the total number of nickel and cerium atoms at all of the 5 measurement points, it can be judged that ceria and nickel oxide are not uniformly mixed.

In this case, ceria and nickel oxide are believed to form a ceria particle and a nickel oxide particle, respectively, which have larger volumes, and exist while creating phase separation in the exhaust gas purification catalyst. Alternatively, it is believed that ceria and nickel oxide are mixed to a certain degree, but due to variation in the size of respective particles of ceria and nickel oxide, these oxides are not uniformly mixed at the nano-level. More specifically, it is believed that in such an exhaust gas purification catalyst, a nickel oxide-ceria interface structure containing a bond like Ni—O—Ce cannot be sufficiently formed, and therefore the effect of enhancing the NOx reduction activity based on the above-described effect due to a combination of ceria and nickel oxide, for example, formation of an oxygen hole in the interface portion of ceria and nickel oxide and/or a reduction-accelerating effect of nickel due to compositing of ceria and nickel oxide, etc., cannot be unfailingly obtained. Actually, experiments by the present inventors have verified that an exhaust gas purification catalyst not satisfying the above conditions in the STEM-EDX analysis cannot achieve a sufficient NOx reducing ability in some cases.

According to the present invention, the “uniform mixing” indicates preferably that when the nanocomposite material is analyzed using STEM-EDX under condition in which the spot size of an electron beam is 1 nm or less, the number of nickel atoms is from 3 to 20 atomic %, especially from 5 to 20 atomic %, from 5 to 15 atomic %, from 5 to 12 atomic %, or from 5 to 10 atomic % relative to the total number of nickel and cerium atoms at 60% or more, especially 70% or more, 80% or more, 90% or more, or 100% or more of randomly selected 5 or more, especially 6 or more, 7 or more, 8 or more, 9 or more or 10 or more measurement points in which both cerium and nickel elements are detected. Using such a nanocomposite material as a catalyst component in the exhaust gas purification catalyst makes it possible to fully exert the above-described effect due to a combination of ceria and nickel oxide. As a result, it is possible to achieve a remarkably improved exhaust gas purification performance, in particular a remarkably improved NOx reducing ability.

In the STEM-EDX analysis, when elemental analysis is carried out on the central portion of the nanocomposite material, an elemental analysis including particles existing behind the measurement point may be carried out to prevent an exact elemental analysis from being performed. Therefore, in the STEM-EDX analysis, the elemental analysis is preferably carried out on measurement points randomly selected along the peripheral edge part of the nanocomposite material.

The expression “randomly selected 5 or more measurement points in which both cerium and nickel elements are detected” in the present invention is intended to merely exclude portions, in which only ceria or nickel oxide aggregates, from the judgment of “uniform mixing of ceria and nickel oxide” in the present invention, since such portions may be formed in part of the exhaust gas purification catalyst of the present invention, although ceria and nickel oxide are uniformly mixed in the catalyst as a whole.

### [Judgment of Uniform Mixing by EXAFS Spectrum]

In place of or in addition to the above-described judgment by STEM-EDX, the “uniform mixing of ceria and nickel oxide” in the present invention can also be judged using an extended X-ray absorption fine structure (EXAFS: Extended X-ray Absorption Fine Structure) spectrum at Ni—K absorption edge regarding the nanocomposite material, as described below.

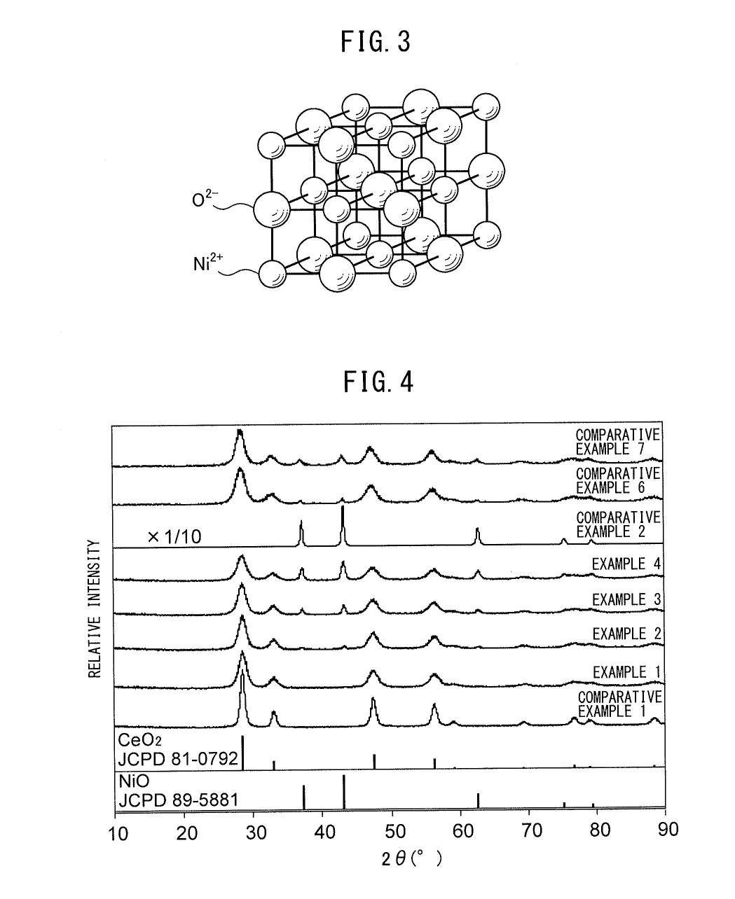

Describing in more detail, nickel oxide (NiO) is known to have a crystal structure of NaCl structure as shown in FIG. 3. Therefore, one Ni atom is adjoined by six O atoms with an interatomic distance of about 1.8 Å, and on the other hand adjoined by twelve Ni atoms with an interatomic distance of about 2.6 Å. Accordingly, in a radial distribution function obtained by Fourier transforming the EXAFS spectrum at Ni—K absorption edge regarding a material of NiO alone or bulk NiO having a larger volume, a peak (a peak attributable to Ni—O) having an intensity according to the number of six O atoms adjoining Ni atom is observed at a position representing an interatomic distance of 1.8 Å, and similarly a peak (a peak attributable to Ni—Ni) having an intensity according to the number of twelve Ni atoms adjoining Ni atom is observed at a position representing an interatomic distance of 2.6 Å.

Meanwhile, in the case of similarly carrying out EXAFS analysis on the “nanocomposite material comprising ceria and nickel oxide which are uniformly mixed” in the present invention, the number of Ni atoms adjoining one Ni atom at a position of an interatomic distance of 2.6 Å is estimated to be small compared with bulk NiO, since ceria and nickel oxide are uniformly mixed at the nano-level. In this case, the ratio of the intensity of a peak attributable to Ni—O near an interatomic distance of 1.8 Å to the intensity of a peak attributable to Ni—Ni near an interatomic distance of 2.6 Å is changed as compared with bulk NiO. Therefore, according to the present invention, uniform mixing of ceria and nickel oxide in the nanocomposite material can be judged by observing these peak intensities in the nanocomposite material and calculating a ratio thereof.

According to the present invention, in the Fourier transform of EXAFS spectrum at Ni—K absorption edge regarding the nanocomposite material, when the ratio of the intensity of a peak attributable to Ni—O near an interatomic distance of 1.8 Å to the intensity of a peak attributable to Ni—Ni near an interatomic distance of 2.6 Å is generally 1:at least 0.50, especially 1:at least 0.70, 1:at least 0.80, or 1:at least 1.00, and generally 1:less than 2.18, especially 1:no more than 2.15, 1:no more than 2.10, 1:no more than 2.06, 1:no more than 2.00, 1:no more than 1.90, 1:no more than 1.80, 1:no more than 1.70, 1:no more than 1.60, 1:no more than 1.50, or 1:no more than 1.40, ceria and nickel oxide can be judged as being uniformly mixed.

In particular, when the above peak intensity ratio is 1:2.18 or more, the number of Ni atoms adjoining one Ni atom at a position of interatomic distance of 2.6 Å is not different from that in bulk NiO, and therefore a nickel oxide-ceria interface structure containing a bond like Ni—O—Ce may not be sufficiently formed. In such a case, the effect of the present invention due to a combination of ceria and nickel, for example, a reduction-accelerating effect of nickel due to compositing of ceria and nickel oxide cannot be unfailingly obtained. Therefore, a sufficient NOx reducing ability cannot be achieved in the finally obtained exhaust gas purification catalyst.

### [X-Ray Diffraction Analysis]

According to a preferred embodiment of the present invention, in the X-ray diffraction with CuKα ray of the nanocomposite material, the height of the diffraction peak around 43.3° attributable to NiO is less than or equal to one-tenth of the height of the diffraction peak around 28.5° attributable to CeO₂. Controlling the height of the diffraction peak around 43.3° attributable to NiO to fall in the above range makes it possible to produce a nanocomposite material in which very fine nickel oxide (NiO) clusters are uniformly mixed with nanoparticles composed of ceria (CeO₂), especially a nanocomposite material in which NiO clusters smaller than nanoparticles composed of ceria are supported on the nanoparticles in very high dispersion.

Accordingly, using such a nanocomposite material as a catalyst component in an exhaust gas purification catalyst makes it possible to form a large number of nickel oxide-ceria interface structures containing a bond like Ni—O—Ce. In this case, the above-described effect of the present invention due to a combination of ceria and nickel oxide can be fully exerted in the finally obtained exhaust gas purification catalyst. As a result, it is possible to achieve a remarkably improved exhaust gas purification performance, especially a remarkably improved NOx reducing ability.

According to a preferred embodiment of the present invention, in the X-ray diffraction with CuKα ray of the nanocomposite material, the height of the diffraction peak around 43.3° attributable to NiO is less than or equal to one-fifteenth, especially less than or equal to one-twentieth, of the height of the diffraction peak around 28.5° attributable to CeO₂, and most preferably, the diffraction peak around 43.3° attributable to NiO is not observed in the X-ray diffraction with CuKα ray of the nanocomposite material.

According to the present invention, the nanocomposite material preferably has a nickel content of greater than 0 mol % to no more than 80 mol % relative to all metal elements contained in the nanocomposite material.

When the nanocomposite material has a nickel content of 0 mol %, i.e., the nanocomposite material contains no nickel, nickel oxide as an active site is of course not present, and therefore a sufficient NOx reduction activity cannot be achieved in the finally obtained exhaust gas purification catalyst. On the other hand, when the nanocomposite material has a nickel content of greater than 80 mol %, nickel may form nickel oxide having a larger volume, resulting in making it impossible to form a nanocomposite material in which the nickel oxide and ceria are uniformly mixed. In this case, the effect of the present invention due to compositing ceria and nickel oxide at the nano-level, especially a reduction-accelerating effect of nickel due to compositing ceria and nickel oxide cannot be achieved. Accordingly, it is believed that the nanocomposite material has an optimal nickel content in view of, for example, the number of active sites of nickel oxide and the reduction-accelerating effect of nickel due to compositing ceria and nickel oxide, etc.

According to the present invention, it is possible to maintain the number of active sites of nickel oxide and fully exert the reduction-accelerating effect of nickel due to compositing ceria and nickel oxide by controlling the nickel content in the nanocomposite material at greater than 0 mol %, especially at least 5 mol %, at least 8 mol %, at least 9 mol %, at least 10 mol %, at least 15 mol %, at least 20 mol %, at least 22 mol %, or at least 25 mol %, and at the same time no more than 80 mol %, especially no more than 75 mol %, no more than 70 mol %, no more than 65 mol %, no more than 60 mol %, no more than 55 mol %, no more than 50 mol %, no more than 45 mol %, no more than 42 mol %, or no more than 40 mol %, for example, greater than 0 mol % to no more than 80 mol %, at least 5 to no more than 70 mol %, at least 8 to no more than 50 mol %, or at least 9 to no more than 42 mol % relative to all metal elements contained in the nanocomposite material. As a result, it is possible to obtain an exhaust gas purification catalyst having a remarkably improved NOx reducing ability. In particular, when the nickel content is at least 9 to no more than 42 mol %, it is possible to obtain an exhaust gas purification catalyst of which NOx reducing ability in the co-presence of oxygen is remarkably improved.

The term “nickel content” in the present invention refers to the ratio of the number of nickel atoms to the total number of nickel and cerium atoms contained in the nanocomposite material. Unless otherwise indicated, the term “nickel content” in the present invention refers to a measured value when the nanocomposite material or exhaust gas purification catalyst is analyzed by an optical method, for example, ICP (inductively coupled plasma) emission analysis. However, depending on the case, the term “nickel content” in the present invention can also be calculated based on each amount of a cerium salt and nickel salt introduced at the time of synthesis of the nanocomposite material.

According to the present invention, ceria in the nanocomposite material preferably has a crystallite size of greater than 0 nm to no more than 10 nm.

When ceria in the nanocomposite material has a crystallite size of greater than 10 nm, the effect due to compositing ceria and nickel oxide may not be sufficiently obtained. In addition, in the case where ceria has such a large crystallite size, the surface area of the nanocomposite material is reduced, leading to a decrease in the number of active sites of nickel oxide, and a sufficient NOx reducing ability may not be achieved in the finally obtained exhaust gas purification catalyst. Therefore, in the exhaust gas purification catalyst of the present invention, ceria in the nanocomposite material preferably has a crystallite size of greater than 0 nm to no more than 10 nm, especially greater than 0 nm to no more than 8 nm, greater than 0 nm to no more than 7 nm, greater than 0 nm to no more than 6.5 nm, greater than 0 nm to no more than 6 nm, greater than 0 nm to no more than 5.8 nm, greater than 0 nm to no more than 5.5 nm, or greater than 0 nm to no more than 5 nm. Using a nanocomposite material having such a ceria crystallite size as a catalyst component makes it possible to fully exert the reduction-accelerating effect of nickel due to compositing ceria and nickel oxide. As a result, it is possible to obtain an exhaust gas purification catalyst having a remarkably improved NOx reducing ability.

Unless otherwise indicated, the term “crystallite size” in the present invention refers to a crystallite size calculated using a crystallite size calculating method by the half-width measurement in powder X-ray diffraction.

According to the present invention, the nanocomposite material preferably has a specific surface area of 90 m²/g or more, more preferably 100 m²/g or more, and most preferably 120 m²/g or more. Controlling the specific surface area of the nanocomposite material to such a range makes it possible to ensure a sufficient contact frequency between the nanocomposite material and the exhaust gas. As a result, it is possible to obtain an exhaust gas purification catalyst having a remarkably improved reduction activity for harmful ingredients contained in the exhaust gas, especially NOx. On the other hand, when the nanocomposite material has a specific surface area of less than 90 m²/g, a sufficient contact frequency between the nanocomposite material and the exhaust gas may not be ensured. As a result, a sufficient NOx reduction activity may not be achieved.

Unless otherwise indicated, the term “specific surface area” in the present invention refers to a specific surface area obtained using a BET adsorption isotherm (so-called BET specific surface area).

According to the present invention, the nanocomposite material preferably has an average primary particle diameter of greater than 0 nm to no more than 20 nm.

When the nanocomposite material has an average primary particle diameter of greater than 20 nm, a nanocomposite material in which ceria and nickel oxide are uniformly mixed at the nano-level cannot be formed. As a result, the reduction-accelerating effect of nickel due to compositing ceria and nickel oxide may not be sufficiently obtained. In addition, when the nanocomposite material has such a large average primary particle diameter, the surface area of the nanocomposite material is reduced, leading to a decrease in the number of active sites of nickel oxide, and a sufficient NOx reducing ability may not be achieved in the finally obtained exhaust gas purification catalyst. Therefore, in the exhaust gas purification catalyst of the present invention, the nanocomposite material has an average primary particle diameter of greater than 0 nm to no more than 20 nm, and more preferably has an average primary particle diameter of greater than 0 nm to no more than 15 nm, greater than 0 nm to no more than 10 nm, greater than 0 nm to no more than 7 nm, greater than 0 nm to no more than 6 nm, or greater than 0 nm to no more than 5 nm.

Unless otherwise indicated, the term “average primary particle diameter” in the present invention refers to an arithmetic mean value of measured values when randomly selected 100 or more particles are measured for the diameter in a fixed direction (Feret diameter) by an electron microscope such as transmission electron microscope (TEM) and scanning electron microscope (SEM).

### [Catalyst Support]

In the exhaust gas purification catalyst of the present invention, the nanocomposite material may be used by supporting it on the later-described catalyst support in any appropriate amount. Although this is not particularly limited, for example, the nanocomposite material may be supported on a catalyst support such that the amount of nickel and/or cerium contained in the nanocomposite material is generally 0.01 wt % or more, 0.1 wt % or more, 0.5 wt % or more, 1 wt % or more, or 2 wt % or more, and/or 10 wt % or less, 8 wt % or less, 7 wt % or less, or 5 wt % or less relative to the catalyst support.

In the case of using the nanocomposite material by supporting it on a catalyst support, the catalyst support may include, but is not particularly limited to, any metal oxide generally known as a catalyst support in the technical field of an exhaust gas purification catalyst. Such a catalyst support includes, for example, silica (SiO₂), zirconia (ZrO₂), alumina (Al₂O₃), titania (TiO₂), or combinations thereof.

In the exhaust gas purification catalyst of the present invention, the nanocomposite material may further contain other additive elements. For example, it is also possible to contain, as an additive element, a noble metal such as platinum (Pt). However, from the standpoint of substituting other metals for a platinum group element, the nanocomposite oxide in the present invention is preferably composed of ceria, nickel oxide and optionally one or more other base metals or oxides thereof, in particular is preferably composed of only ceria and nickel oxide. Actually, according to the present invention, NOx in an exhaust gas can be purified by reduction without using a platinum group element such as Pt, Pd and Rh, and therefore the exhaust gas purification catalyst of the present invention is very advantageous compared with a conventional exhaust gas purification catalyst comprising nickel or nickel oxide.

### <Production Method of Exhaust Gas Purification Catalyst>

The present invention further provides a production method of an exhaust gas purification catalyst, where an exhaust gas purification catalyst comprising the above-described nanocomposite material can be produced. The production method introducing a basic substance into an aqueous solution containing cerium ions, nickel ions and a surfactant; hydrothermally treating the resulting mixed solution to form a nanocomposite material precursor; and drying and firing the nanocomposite material precursor.

First of all, it is generally very difficult to produce a material in which ceria and nickel oxide are composited at the nano-level.

As a method for producing an exhaust gas purification catalyst comprising a composite material composed of a plurality of metal elements or metal oxides, for example, a so-called impregnation method, in which metal elements are supported by impregnating an oxide of another metal element with a solution containing salts of these metal elements, is generally known. However, it is difficult to form a nanocomposite material comprising a particular combination of ceria and nickel oxide, in which these oxides are composited at the nano-level, by such conventional impregnation method. In addition, in an exhaust gas purification catalyst obtained by such a method, ceria and nickel oxide are believed to be present as a ceria particle and a nickel oxide particle, respectively, which have larger volumes, and create phase separation in the exhaust gas purification catalyst. Accordingly, a sufficient NOx reducing ability cannot be achieved in an exhaust gas purification catalyst obtained by supporting nickel on ceria by the conventional impregnation method.

On the other hand, as another method for producing an exhaust gas purification catalyst comprising a composite material composed of a plurality of metal elements or metal oxides, a so-called coprecipitation method comprising adding a basic substance such as aqueous ammonia to a mixed solution having salts of respective metal elements constituting the composite material dissolved therein, thereby causing coprecipitation, and heat-treating the obtained precipitate is generally known. However, even by such a conventionally known coprecipitation method, as in the case of the impregnation method, it is difficult to form a nanocomposite material in which ceria and nickel oxide are uniformly mixed at the nano-level. Even if a composite material comprising ceria and nickel oxide which are mixed is produced by such a method, unless these oxides are uniformly mixed at the nano-level, i.e., uniformly composited at the nano-level, the characteristic effect of the present invention due to a combination of ceria and nickel oxide is believed to be less likely obtained.

The present inventors have found that unlike the method using a conventionally known impregnation method or coprecipitation method, it is possible to prepare a nanocomposite material comprising ceria and nickel oxide, which are uniformly mixed at the nano-level, by introducing a basic substance into an aqueous solution containing a surfactant in addition to cerium ions and nickel ions, and further hydrothermally treating the obtained mixed solution.

Without being bound by any particular theory, it is believed that use of a surfactant can prevent primary particles from fusing with each other at the time of introduction of a basic substance. Therefore, it is believed that fine and uniform crystal grains can be prepared by the subsequent hydrothermal treatment.

Describing in more detail, in the case where a surfactant is not present, when a basic substance is introduced into an aqueous solution containing a cerium ion and a nickel ion, hydroxides formed are fused with each other to form a larger primary particle. Therefore, even when a hydrothermal treatment is thereafter performed, a nanocomposite material precursor, in which ceria and nickel oxide are uniformly mixed, cannot be formed.

On the other hand, in the case where a surfactant is present, it is believed that since the surfactant forms micelles in the aqueous solution, even when a solution containing cerium ions and nickel ions is added to the aqueous solution and a basic substance is further introduced thereto, the micelles provide steric hindrance to suppress fusion of hydroxides with each other. That is, it is believed that hydroxides formed by introduction of a basic substance are considered to be maintained in a fine state in a gap between micelles. Thereafter, the obtained gelled solution is put in an autoclave, etc., and hydrothermally treated at a predetermined temperature, whereby crystallization of the grain can be accelerated. Although this is not particularly limited, generally, the hydrothermal treatment can be carried out using an autoclave at a temperature of 90 to 200° C., preferably 100 to 150° C. for 5 to 40 hours, preferably 10 to 30 hours.

Finally, the precipitate obtained after the hydrothermal treatment is subjected to, if necessary, washing, etc., and then dried and fired at a predetermined temperature to form a nanocomposite material comprising ceria and nickel oxide which are uniformly mixed. The above drying and firing can be carried out at a temperature and for a time period sufficient to decompose and remove the surfactant and form oxides of cerium and nickel. Although this is not particularly limited, for example, the drying can be carried out under reduced pressure or atmospheric pressure at a temperature of about 80° C. to about 250° C. for about 1 hour to about 24 hours, and on the other hand, the firing can be carried out in air or an oxidizing atmosphere at a temperature of about 300° C. to about 800° C. for about 1 hour to about 10 hours.

### [Cerium Ion Source and Nickel Ion Source]

The cerium ion source and nickel ion source may include, but are not particularly limited to, for example, nitrates, acetates and sulfates, etc., of these metals. In the method of the present invention, predetermined amounts of a cerium ion source and a nickel ion source are dissolved in water to prepare an aqueous solution containing cerium ions and nickel ions.

### [Surfactant]

According to the method of the present invention, the surfactant may be sufficient if it can form micelles in the aqueous solution, and includes, but is not particularly limited to, for example, an anionic surfactant, a cationic surfactant, an amphoteric surfactant, a nonionic surfactant, or combinations thereof. The surfactant can be added in an amount and a concentration sufficient to form micelles in an aqueous solution containing cerium ions and nickel ions, more specifically in a concentration not less than the critical micell concentration.

The anionic surfactant includes, but is not particularly limited to, for example, a fatty acid salt, an alkylsulfuric acid ester salt, a polyoxyethylene alkyl ether sulfuric acid ester salt, an alkylbenzenesulfonate, an alkylnaphthalenesulfonate, a dialkylsulfosuccinate, an alkyldiphenyl ether disulfonate, a polyoxyethylene alkyl ether phosphate, an alkenylsuccinate, an alkanesulfonate, a naphthalenesulfonic acid-formalin condensate salt, an aromatic sulfonic acid-formalin condensate salt, a polycarboxylic acid, and a polycarboxylate, etc.

The cationic surfactant includes, but is not particularly limited to, for example, an alkylamine salt and an alkyl quaternary ammonium salt, etc., especially cetyltrimethylammonium chloride (CTAC), cetyltrimethylammonium bromide (CTAB), etc. The amphoteric surfactant includes, but is not particularly limited to, for example, an alkylbetaine and an alkylamine oxide, etc.

The nonionic surfactant includes, but is not particularly limited to, for example, a polyoxyethylene alkyl ether, a polyoxyalkylene alkyl ether, a polyoxyethylene derivative, a sorbitan fatty acid ester, a polyoxyethylene sorbitan fatty acid ester, a polyoxyethylene sorbitol fatty acid ester, a glycerin fatty acid ester, a polyoxyethylene fatty acid ester, a polyoxyethylene hardened castor oil, a polyoxyethylene alkylamine, and an alkylalkanolamide, etc.

### [Basic Substance]

The basic substance may be sufficient if it can react with cerium ions and nickel ions in the solution to form hydroxides, and includes, but is not particularly limited to, for example, an inorganic compound such as sodium hydroxide (NaOH), potassium hydroxide (KOH), ammonia (NH₃) and sodium carbonate (Na₂CO₃). The basic substance also may include, for example, an organic compound such as pyridine and (poly)ethylenediamine compound, preferably a (poly)ethylenediamine.

The (poly)ethylenediamine compound may include those having 1 to 10 ethylene units, especially 1 to 6 ethylene units. Specifically, the preferable polyethylenediamine compounds may include ethylenediamine (EDA: H₂NCH₂CH₂NH₂), diethylenetriamine (DETA: H₂NCH₂CH₂NHCH₂CH₂NH₂), triethylenetetramine (TETA: H₂NCH₂CH₂NHCH₂CH₂NHCH₂CH₂NH₂), tetraethylenepentamine [TEPA: H₂N(CH₂CH₂NH)₃CH₂CH₂NH₂)], and pentaethylenehexamine [PEHA: H₂N(CH₂CH₂NH)₄H₂CH₂NH₂], especially ethylenediamine (DDA).

At the time of addition of a basic substance, the pH of the solution is preferably adjusted to the range of 7 to 11. When the pH is too low, a hydroxide precipitation reaction may not occur. On the other hand, when the pH is too high, the precipitated hydroxide may be dissolved.

The nanocomposite material obtained as above may be used, if necessary, by supporting it on a catalyst support. The catalyst support may include, but is not particularly limited to, any metal oxide generally known as a catalyst support in the technical field of exhaust gas purification catalyst. As described above, such a catalyst support includes, for example, silica (SiO₂), zirconia (ZrO₂), alumina (Al₂O₃), titania (TiO₂), or combinations thereof.

Finally, if necessary, the exhaust gas purification catalyst of the present invention obtained as above may be used, for example, by pressing the exhaust gas purification catalyst under high pressure to shape it into a pellet form, or by adding a predetermined binder, etc., to the exhaust gas purification catalyst to form a slurry and coating a catalyst substrate such as a cordierite-made honeycomb substrate with the slurry.

The present invention is described in more detail below based on Examples, but the present invention is not limited thereto.

### EXAMPLES

In the following Examples, various exhaust gas purification catalysts comprising a composite material composed of ceria and nickel oxide were prepared, and examined for their properties and NOx purification performance.

### Example 1

### Preparation of NiO—CeO₂ Composite Material (Ni1Ce9: Charged Ni Content: 10 Mol %)

First, 750 mg (3 mmol) of nickel acetate tetrahydrate (Ni(CH₃COO)₂.4H₂O) and 11.7 g (27 mmol) of cerium nitrate hexahydrate (Ce(NO₃)₃.6H₂O) were put in a 1,000 mL beaker and dissolved with 225 mL of distilled water (Solution 1). Then, 4.4 g (12 mmol) of cetyltrimethylammonium bromide (CTAB) was put in a 500 mL beaker and completely dissolved with 150 mL of distilled water (Solution 2). Then, Solution 2 was added to Solution 1, and the mixed solution was stirred at room temperature for 2 hours. While vigorously stirring this solution, about 60 mL of an aqueous 1 M NaOH solution was quickly poured in the solution, and the pH was thereby adjusted to 9.5.

Next, the gelled solution obtained was stirred at room temperature for 4 hours, then was put in a Teflon-made autoclave and hydrothermally treated at 120° C. for 24 hours. After cooling to room temperature, the obtained solution was centrifuged (3,000 rpm×10 minutes) to obtain a precipitate. Then, about 300 mL of acetone was added to the obtained precipitate to disperse the precipitate into the acetone. The dispersion was again centrifuged (3,000 rpm×10 minutes), and the precipitate was washed. Then, the precipitate was collected in a 50 mL beaker and dried at 120° C. for 3 hours, and the obtained solid was ground in a mortar. Finally, the obtained powder was fired in air at 500° C. for 4 hours, compression-molded under a pressure of 2 t, and the molded powder was then pulverized and sieved to obtain an exhaust gas purification catalyst composed of a pellet-shaped NiO—CeO₂ composite material of 1.0 to 1.7 mm (Ni1Ce9: charged Ni content: 10 mol %).

### Example 2

### Preparation of NiO—CeO₂ Composite Material (Ni2Ce8: Charged Ni Content: 20 Mol %)

An exhaust gas purification catalyst composed of a NiO—CeO₂ composite material (Ni2Ce8: charged Ni content: 20 mol %) was obtained in the same manner as in Example 1, except that 1.49 g (6 mmol) of nickel acetate tetrahydrate and 10.4 g (24 mmol) of cerium nitrate hexahydrate were put in a 1,000 mL beaker and dissolved with 225 mL of distilled water.

### Example 3

### Preparation of NiO—CeO₂ Composite Material (Ni4Ce6: Charged Ni Content: 40 Mol %)

An exhaust gas purification catalyst composed of a NiO—CeO₂ composite material (Ni4Ce6: charged Ni content: 40 mol %) was obtained in the same manner as in Example 1, except that 2.99 g (12 mmol) of nickel acetate tetrahydrate and 7.82 g (18 mmol) of cerium nitrate hexahydrate were put in a 1,000 mL beaker and dissolved with 225 mL of distilled water.

### Example 4

### Preparation of NiO—CeO₂ Composite Material (Ni7Ce3: Charged Ni Content: 70 Mol %)

An exhaust gas purification catalyst composed of a NiO—CeO₂ composite material (Ni7Ce3: charged Ni content: 70 mol %) was obtained in the same manner as in Example 1, except that 5.23 g (21 mmol) of nickel acetate tetrahydrate and 3.91 g (9 mmol) of cerium nitrate hexahydrate were put in a 1,000 mL beaker and dissolved with 225 mL of distilled water.

### Comparative Example 1

### Preparation of CeO₂ (Charged Ni Content: 0 Mol %)

An exhaust gas purification catalyst composed of only CeO₂ (charged Ni content: 0 mol %) was obtained in the same manner as in Example 1, except that only 13.03 g (30 mmol) of cerium nitrate hexahydrate was put in a 1,000 mL beaker and dissolved with 225 mL of distilled water.

### Comparative Example 2

### Preparation of NiO (Charged Ni Content: 100 Mol %)

An exhaust gas purification catalyst composed of only NiO (charged Ni content: 100 mol %) was obtained in the same manner as in Example 1, except that only 7.47 g (30 mmol) of nickel acetate tetrahydrate was put in a 1,000 mL beaker and dissolved with 225 mL of distilled water.

### Comparative Example 3

### Preparation of NiO/CeO₂ (Supported Ni Amount: 5 wt %) by Impregnation Method

First, 100 mL of distilled water was put in a 300 mL beaker, and 6.36 g of nickel acetate tetrahydrate was added thereto and completely dissolved. Then, 30 g of ceria (CeO₂) (C. I. Kasei Co., Ltd., NanoTek Ceria, BET specific surface area: 53 m²/g) was added to the resulting solution and heated to remove the solvent. Then, the obtained solid was dried at 120° C. for 1 hour and ground in a mortar to prepare a uniform powder, and this powder was fired in air at 500° C. for 2 hours. Finally, the obtained powder was compression-molded under a pressure of 2 t, and the molded powder was then pulverized and sieved to obtain an exhaust gas purification catalyst composed of a pellet-shaped NiO/CeO₂ of 1.0 to 1.7 mm (supported Ni content: 5 wt %).

### Comparative Example 4

### Preparation of NiO/CeO₂ (Supported Ni Amount: 10 wt %) by Impregnation Method

An exhaust gas purification catalyst composed of NiO/CeO₂ (supported Ni content: 10 wt %) was obtained in the same manner as in Comparative Example 3, except that 100 mL of distilled water was put in a 300 mL beaker and 12.7 g of nickel acetate tetrahydrate was added thereto and completely dissolved.

### Comparative Example 5

### Preparation of NiO/CeO₂ (Supported Ni Amount: 20 wt %) by Impregnation Method

An exhaust gas purification catalyst composed of NiO/CeO₂ (supported Ni content: 20 wt %) was obtained in the same manner as in Comparative Example 3, except that 100 mL of distilled water was put in a 300 mL beaker and 25.4 g of nickel acetate tetrahydrate was added thereto and completely dissolved.

### Comparative Example 6

### Preparation of NiO—CeO₂ Composite Material (Ni1Ce9: Charged Ni Content: 10 Mol %) by Coprecipitation Method

First, 750 mg (3 mmol) of nickel acetate tetrahydrate and 11.7 g (27 mmol) of cerium nitrate hexahydrate were put in a 1,000 mL beaker and dissolved with 400 mL of distilled water. Then, about 60 mL of an aqueous 1 M NaOH solution was poured in the resulting solution, and the pH was thereby adjusted to 9.5. Next, this solution was stirred at room temperature for 4 hours, then put in a Teflon-made autoclave and hydrothermally treated at 120° C. for 24 hours. After cooling to room temperature, the obtained solution was centrifuged (3,000 rpm×10 minutes) to obtain a precipitate. Then, about 300 mL of acetone was added to the obtained precipitate to disperse the precipitate into the acetone. The dispersion was again centrifuged (3,000 rpm×10 minutes), and the precipitate was washed. Then, the precipitate was collected in a 50 mL beaker and dried at 120° C. for 3 hours, and the obtained solid was ground in a mortar. Finally, the obtained powder was fired in air at 500° C. for 4 hours, compression-molded under a pressure of 2 t, and the molded powder was then pulverized and sieved to obtain an exhaust gas purification catalyst composed of a pellet-shaped NiO—CeO₂ composite material of 1.0 to 1.7 mm (Ni1Ce9: charged Ni content: 10 mol %).

### Comparative Example 7

### Preparation of NiO—CeO₂ Composite Material (Ni4Ce6: Charged Ni Content: 40 Mol %) by Coprecipitation Method

An exhaust gas purification catalyst composed of a NiO—CeO₂ composite material (Ni4Ce6: charged Ni content: 40 mol %) was obtained in the same manner as in Comparative Example 6, except that 2.99 g (12 mmol) of nickel acetate tetrahydrate and 7.82 g (18 mmol) of cerium nitrate hexahydrate were put in a 1,000 mL beaker and dissolved with 400 mL of distilled water.

### [Composition Analysis of Catalyst by ICP Emission Analysis]

The exhaust gas purification catalysts of Example 1 to 4 and Comparative Examples 1 to 7 were analyzed for the composition by dissolving each of these exhaust gas purification catalysts in aqua regia and quantitatively determining the Ni content and Ce content in the solution. The analysis was performed using an ICP (inductively coupled plasma) emission analyzer (ICPV-8100; manufactured by Shimadzu Corporation). The results obtained are shown in Table 1. Table 1 also shows the catalyst configuration, the charged Ni content, etc., regarding these exhaust gas purification catalysts.

TABLE 1
Composition Analysis of Each Catalyst by ICP
Emission Analysis

| | Catalyst | | Analysis by | |
|---|---|---|---|---|
| | Configuration | | ICP (mol %) | |
| | (charged | | Ni | Ce |
| | Ni content) | Surfactant | Content | Content |
| Example 1 | NiO—CeO₂ | CTAB | 9 | 91 |
| | (10 mol %) | | | |
| Example 2 | NiO—CeO₂ | CTAB | 22 | 78 |
| | (20 mol %) | | | |
| Example 3 | NiO—CeO₂ | CTAB | 42 | 58 |
| | (40 mol %) | | | |
| Example 4 | NiO—CeO₂ | CTAB | 65 | 35 |
| | (70 mol %) | | | |
| Comparative Example 1 | CeO₂ | CTAB | 0 | 100 |
| | (0 mol %) | | | |
| Comparative Example 2 | NiO | CTAB | 100 | 0 |
| | (100 mol %) | | | |
| Comparative Example 3 | NiO—CeO₂ | — | 13 | 87 |
| (impregnation method) | (12.8 mol %) | | | |
| Comparative Example 4 | NiO—CeO₂ | — | 23 | 77 |
| (impregnation method) | (22.7 mol %) | | | |
| Comparative Example 5 | NiO—CeO₂ | — | 37 | 63 |
| (impregnation method) | (36.9 mol %) | | | |
| Comparative Example 6 | NiO—CeO₂ | — | 11 | 89 |
| (coprecipitation method) | (10 mol %) | | | |
| Comparative Example 7 | NiO—CeO₂ | — | 47 | 53 |
| (coprecipitation method) | (40 mol %) | | | |

As shown in Table 1, in all exhaust gas purification catalysts, the Ni content showed good agreement between the charged value and the measured value by ICP emission analysis.

### [Structural Analysis of Catalyst by Nitrogen Adsorption Method]

Next, with respect to the exhaust gas purification catalysts of Examples 1 to 4 and Comparative Examples 1, 2, 6 and 7, the structural features thereof were examined by the nitrogen adsorption method. The results obtained are shown in Table 2. The average pore size and the pore volume in Table 2 were calculated by BJH method from a nitrogen adsorption isotherm.

TABLE 2
Structural Analysis of Each Catalyst by Nitrogen
Adsorption Method

| | | BET | | Average |
|---|---|---|---|---|
| | | Specific | Average | Pore |
| | | Surface | Pore Size | Volume |
| | | Area (m²/g) | (nm) | (cm³/g) |
| Example 1 | Ni1Ce9 | 130 | 3.4 | 0.094 |
| Example 2 | Ni2Ce8 | 101 | 3.7 | 0.066 |
| Example 3 | Ni4Ce6 | 91 | 4.7 | 0.078 |
| Example 4 | Ni7Ce3 | 103 | 7.3 | 0.200 |
| Comparative | CeO₂ | 85 | 5.1 | 0.117 |
| Example 1 | | | | |
| Comparative | NiO | 24 | 20.6 | 0.144 |
| Example 2 | | | | |
| Comparative | Ni1Ce9 by | 119 | 4.0 | 0.147 |
| Example 6 | coprecipitation | | | |
| | method | | | |
| Comparative | Ni4Ce6 by | 67 | 6.1 | 0.123 |
| Example 7 | coprecipitation | | | |
| | method | | | |

The exhaust gas purification catalysts of Examples 1 to 4 showed a high specific surface area, compared with the exhaust gas purification catalysts of Comparative Example 1 using CeO alone and Comparative Example 2 using NiO alone. In particular, the exhaust gas purification catalyst of Example 1 (Ni1Ce9) showed a highest specific surface area (130 m²/g). On the other hand, the exhaust gas purification catalysts of Comparative Examples 6 and 7 prepared by the conventional coprecipitation method showed a relatively high specific surface area, but the values thereof were small, compared with the exhaust gas purification catalysts of Examples 1 and 3 having the same charged Ni content.

As for the average pore size, the exhaust gas purification catalyst of Example 4 showed a higher value than that of the exhaust gas purification catalyst of Comparative Example 1, but the exhaust gas purification catalysts of other Examples showed a small pore size, compared with the exhaust gas purification catalysts of Comparative Example 1 using CeO₂ alone and Comparative Example 2 using NiO alone. In particular, the exhaust gas purification catalyst of Example 1 (Ni1Ce9) showed a smallest pore size (3.4 nm). This is believed to be due to the fact that fusion of clusters was prevented by interaction of CeO₂ and NiO.

### [Structural Analysis of Catalyst by X-Ray Diffraction (XRD)]

The exhaust gas purification catalysts of Examples 1 to 4 and Comparative Examples 1, 2, 6 and 7 were measured by X-ray diffraction (XRD) (RINT2000, manufactured by Rigaku Corporation). Specific measurement conditions are as follows.
Measuring method: FT method (Fixed Time method)
X-Ray source: CuKα
Sampling interval: 0.02 deg.
Scan speed: 2.4 deg./min
Divergence slit (DS): 2/3 deg.
Scattering slit (SS): 2/3 deg.
Light receiving slit (RS): 0.5 mm
Tube voltage: 50 kV
Tube current: 300 mA

In addition, the ceria crystallite size of each of these exhaust gas purification catalysts is shown in Table 3. These values were obtained by determining the half width from the diffraction peak assigned to (111) plane of CeO₂ and calculating the crystallite size from the obtained value using the crystallite size calculating method.

TABLE 3
CeO₂ Crystallite Size of Each Catalyst

| | | CeO₂ Crystallite Size (nm) |
|---|---|---|
| Example 1 | Ni1Ce9 | 5.8 |
| Example 2 | Ni2Ce8 | 6.1 |
| Example 3 | Ni4Ce6 | 5.7 |
| Example 4 | Ni7Ce3 | 5.0 |
| Comparative | CeO₂ | 10.9 |
| Example 1 | | |
| Comparative | NiO | 27.2 |
| Example 2 | | |
| Comparative | Ni1Ce9 by | 6.0 |
| Example 6 | coprecipitation method | |
| Comparative | Ni4Ce6 by | 6.1 |
| Example 7 | coprecipitation method | |

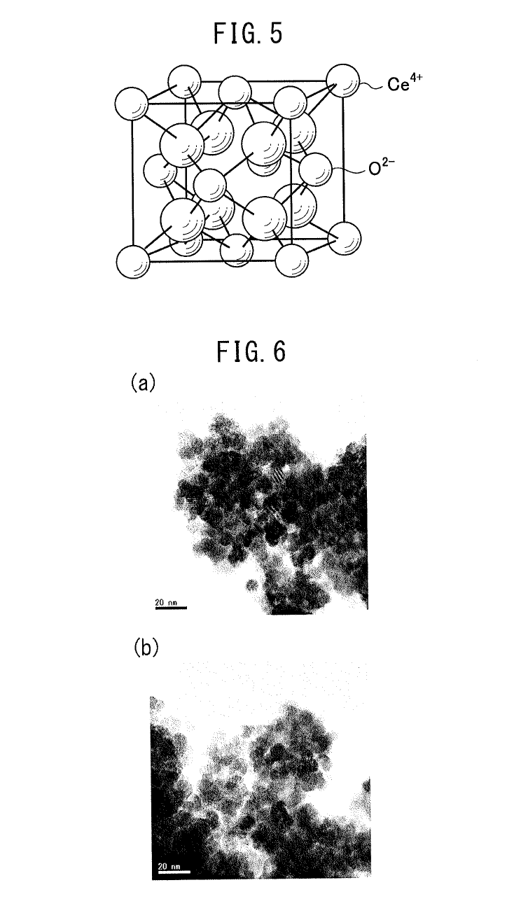

FIG. 4 shows an X-ray diffraction pattern regarding the exhaust gas purification catalysts of Examples 1 to 4 and Comparative Examples 1, 2, 6 and 7. FIG. 4 also shows literature values regarding respective diffraction peaks of CeO₂ and NiO for reference. Referring to FIG. 4, in all exhaust gas purification catalysts except for Comparative Example 2 (NiO), a diffraction peak based on the fluorite structure (see FIG. 5) of CeO₂ was detected. In addition, in the exhaust gas purification catalysts of Comparative Examples 6 and 7 and the exhaust gas purification catalysts of Examples 2 to 4 where the charged Ni content was 20 mol % or more, a diffraction peak based on the NaCl structure of NiO as well as the diffraction peak of CeO₂ were detected. Here, in the exhaust gas purification catalyst of Comparative Example 6, the height of the diffraction peak around 43.3° attributable to NiO was about one-seventh of the height of the diffraction peak around 28.5° attributable to CeO₂.

On the other hand, in the exhaust gas purification catalyst of Example 1 where the charged Ni content was 10 mol %, a diffraction peak based on the NaCl structure of NiO was not detected. In addition, in the exhaust gas purification catalyst of Example 1, no peak shift was observed in particular with respect to the diffraction peak of CeO₂. Accordingly, it is believed that in the exhaust gas purification catalyst of Example 1, without allowing ceria and nickel oxide to form a so-called solid solution, a structure consisting of CeO₂ having dispersed thereon fine atomic-level NiO clusters undetected by X-ray diffraction was formed or an amorphous nickel oxide was formed.

Referring to the results of Table 3, particularly in the exhaust gas purification catalysts of Examples 1 to 4, the crystallite size of ceria had a tendency to decrease as the charged Ni content increases. This suggests that growth of a ceria crystallite was suppressed by the compositing with nickel oxide. On the other hand, in the exhaust gas purification catalysts of Comparative Examples 6 and 7 prepared by the conventional coprecipitation method, the ceria crystallite size was comparable to that of the exhaust gas purification catalyst of the present invention. However, as shown in FIG. 3, while a diffraction peak based on the NaCl structure of NiO was detected in the exhaust gas purification catalyst of Comparative Example 6, a diffraction peak based on the NaCl structure of NiO was not detected in the exhaust gas purification catalysts of Example 1 having the same composition. Thus, it was verified that in the exhaust gas purification catalyst of Comparative Example 6, the NiO crystal is segregated as compared with the exhaust gas purification catalyst of Example 1 having the same composition.

### [Analysis of Catalyst by STEM-EDX]

The exhaust gas purification catalysts of Examples 1 to 3 and Comparative Examples 1, 6 and 7 were measured by a scanning transmission electron microscope equipped with an energy dispersive X-ray analyzer (STEM-EDX) (JEM1000, manufactured by JEOL, accelerating voltage: 200 kV). Here, each measurement sample was diluted with ethanol, dropped on a molybdenum grid, dried and then measured. FIGS. 6 to 11 show the results.

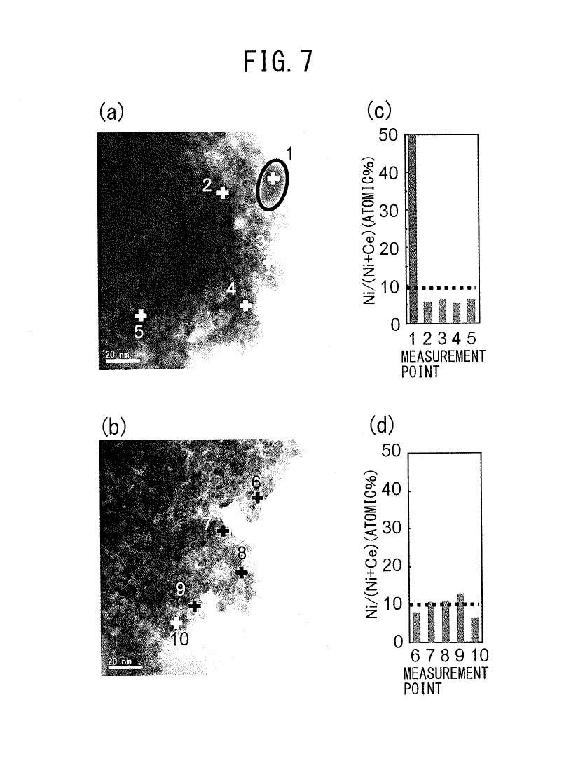

FIGS. 6 to 11 show the analysis results of the exhaust gas purification catalysts of Examples 1 to 3 and Comparative Examples 1, 6 and 7 by STEM-EDX. Specifically, FIGS. 6(a) and (b) show photographs of the exhaust gas purification catalyst of Comparative Example 1 by STEM-EDX; and FIGS. 7 to 11 (a) and (b) show show photographs of the exhaust gas purification catalysts of Examples 1 to 3 and Comparative Examples 6 and 7 by STEM-EDX, respectively, and FIGS. 7 to 11 (c) and (d) show the ratio (atomic %) of the number of Ni atoms relative to the total number of Ni and Ce atoms at each measurement point in (a) and (b). Here, the dashed line in FIGS. 7 to 11 (c) and (d) indicates the measured value when each of these exhaust gas purification catalysts is analyzed by ICP emission analysis, i.e., the measured value of the bulk composition.

Referring to FIGS. 6(a) and (b), in the exhaust gas purification catalyst of Comparative Example 1 using CeO₂ alone, the presence of CeO₂ primary particles having a particle diameter of about 10 nm can be confirmed. On the other hand, referring to FIGS. 7 to 11(a) and (b), it can be recognized that in the exhaust gas purification catalysts of Examples 1 to 3 and Comparative Examples 6 and 7, compositing of NiO and CeO₂ brought about the formation of a primary particle smaller than that in the exhaust gas purification catalyst of Comparative Example 1, particularly a primary particle having a particle diameter on the order of about 5 nm.

Next, describing the composition analysis by EDX, in the exhaust gas purification catalyst (Ni1Ce9) of Example 1, the ratio of Ni was 100 atomic % at measurement point 1 (FIG. 7(c)). Here, in FIGS. 7 to 11(c) and (d), the ratio of Ni is 100 atomic % at all measurement points where the ratio of Ni exceeds 50 atomic %. In FIGS. 7 to 10(a), the marking indicates a portion where an NiO crystal is considered to be formed. Accordingly, it is understood that in the exhaust gas purification catalyst of Example 1, a crystal composed of only NiO was observed at measurement point 1, but the ratio of Ni is about 6 to about 12 atomic % at all other measurement points, and therefore a nanocomposite material comprising CeO₂ and NiO, which were very uniformly mixed, was formed.

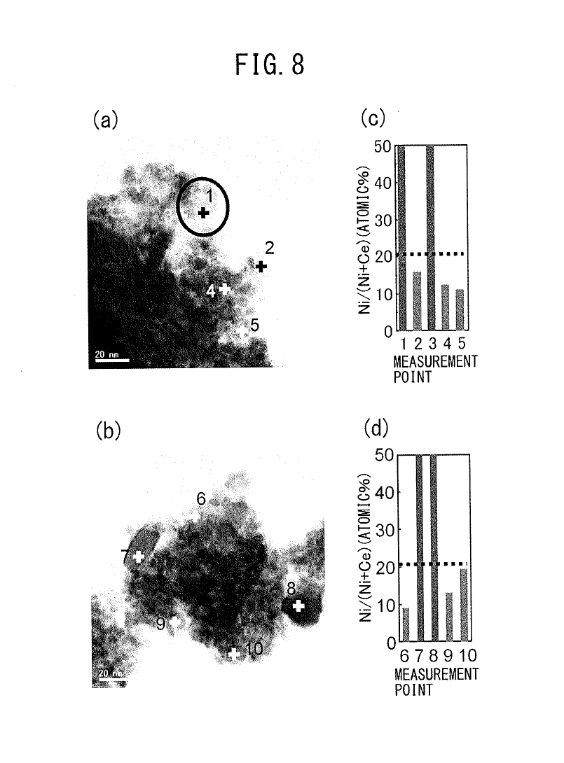

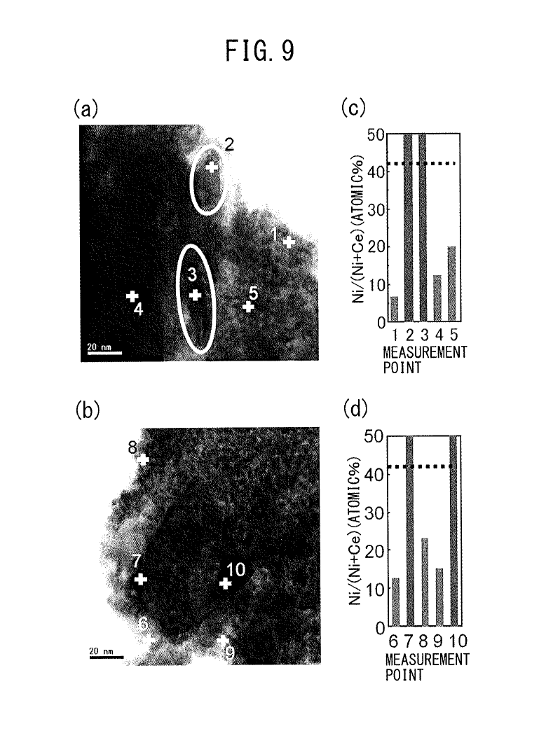

Referring to FIGS. 8 and 9(c) and (d), in the exhaust gas purification catalysts (Ni2Ce8 and Ni4Ce6) of Examples 2 and 3, precipitation of an NiO crystal was increased as compared with the exhaust gas purification catalyst (Ni1Ce9) of Example 1, and the ratio of Ni was slightly varied even at a measurement point in which both Ce and Ni elements were detected. However, in both of Examples 2 and 3, the ratio of Ni is from about 5 to about 20 atomic % at a majority or all of these measurement points, and therefore it was verified that in these Examples, a nanocomposite material comprising CeO₂ and NiO, which were relatively uniformly mixed, was formed.

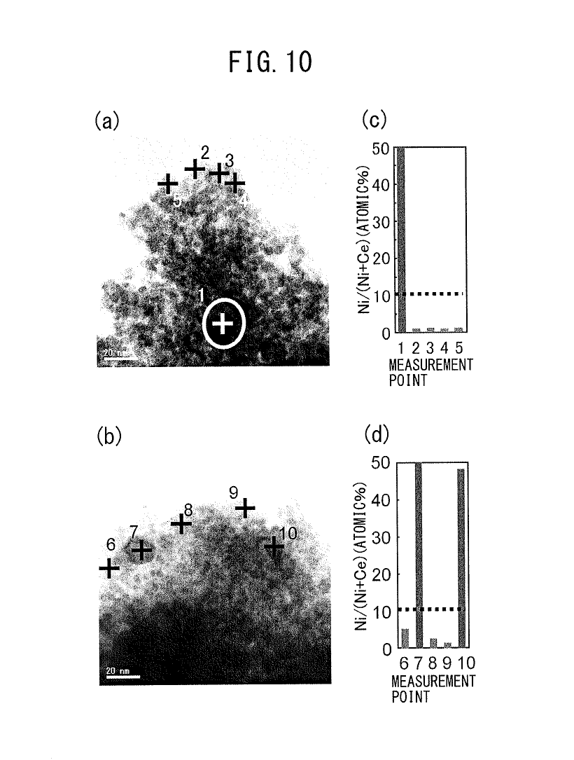

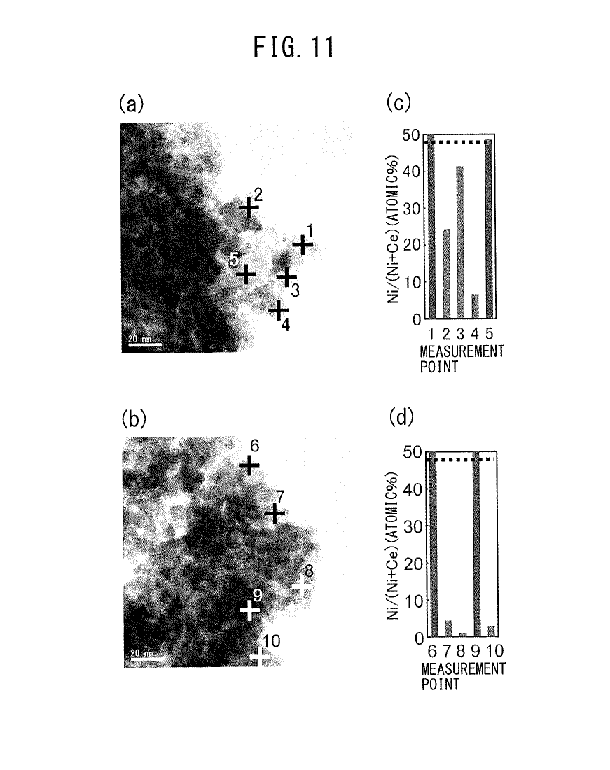

On the other hand, referring to FIGS. 10(c) and (d), in the exhaust gas purification catalyst (Ni1Ce9 by coprecipitation method) of Comparative Example 6 prepared by the conventional coprecipitation, the ratio of Ni was on the order of about 1 atomic % at measurement points 2 to 5, and the ratio of Ni was from 3 to 20 atomic % only at measurement point 6 of the measurement points in which both Ce and Ni elements were detected. This was highly contrasting as compared with the results of the exhaust gas purification catalyst (Ni1Ce9) of Example 1 having the same composition. In addition, referring to FIGS. 11(c) and (d), in the exhaust gas purification catalyst (Ni4Ce6 by coprecipitation method) of Comparative Example 7, precipitation of an NiO crystal was increased as compared with the exhaust gas purification catalyst (Ni1Ce9 by coprecipitation method) of Comparative Example 6, and the ratio of Ni was significantly varied even at a measurement point in which both Ce and Ni elements were detected. These results suggest that in the exhaust gas purification catalysts of Comparative Examples 6 and 7 prepared by the conventional coprecipitation method, the NiO crystal was segregated. In addition, these results also coincide with the analysis results by X-ray diffraction of FIG. 4.

### [Catalyst Activity Evaluation]

Next, the exhaust gas purification catalysts of Examples 1 to 4 and Comparative Examples 1 to 6 were evaluated for the NOx reducing ability in an NO—CO reaction of following formula (1):

NO+CO→1/2N₂+CO₂ (1)

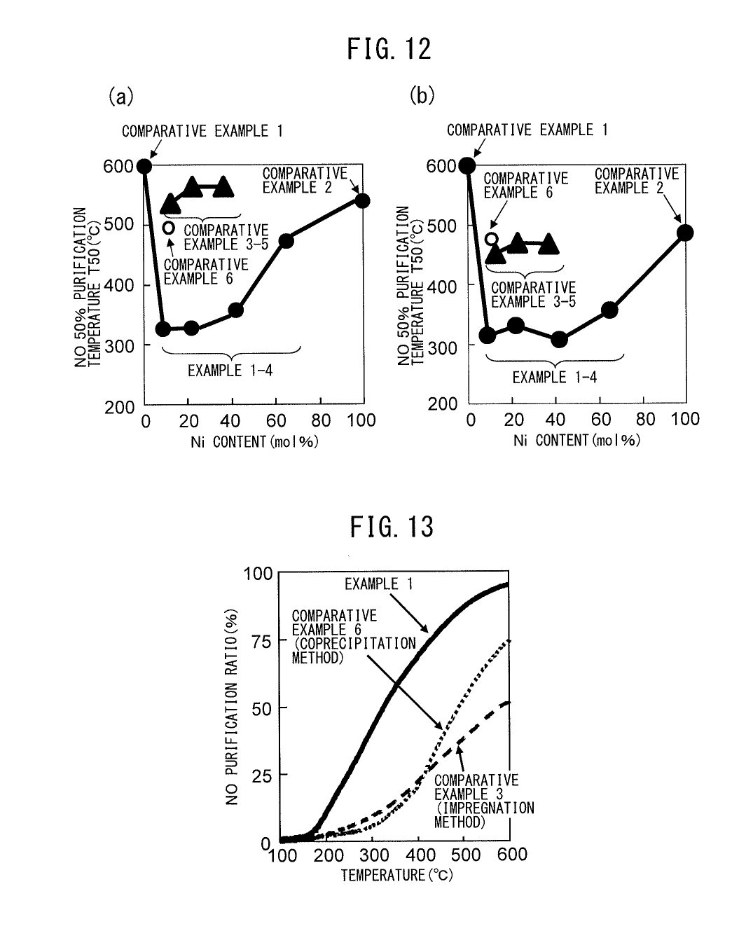

Specifically, 0.3 g of a pellet-shaped exhaust gas purification catalyst was put in a flow-type reacting furnace, and the temperature of the catalyst bed was elevated from room temperature to 600° C. at a rate of 20° C./min while flowing a model gas 1 for evaluation (NO: 3,000 ppm, CO: 3,000 ppm, N₂ balance) at a flow rate of 1 L/min to the catalyst bed and held at 600° C. for a predetermined time. Thereafter, the temperature of the catalyst bed was lowered from 600° C. to 100° C. at a rate of 20° C./min, and the temperature at which the NO purification ratio dropped from near 100% to 50% (NO 50% purification temperature T50) was measured. Furthermore, in order to examine the behavior in the presence of oxygen, an evaluation when using an oxygen-containing model gas 2 for evaluation (NO: 3,000 ppm, CO: 6,000 ppm, O₂: 1,500 ppm, N₂ balance) was carried out in the same manner. The results thereof are shown in FIGS. 12(a) and (b). Here, the analysis was performed using an activity evaluation device (SESAM3-HL, manufactured by Best Instruments Co., Ltd.) equipped with an FT-IR analyzer and a paramagnetic analyzer.

FIG. 12(a) shows the NO 50% purification temperature T50 regarding the exhaust gas purification catalysts of Examples 1 to 4 and Comparative Examples 1 to 6 when oxygen is present, and FIG. 12(b) shows the NO 50% purification temperature T50 regarding the exhaust gas purification catalysts of Examples 1 to 4 and Comparative Examples 1 to 6 when oxygen is not present. Each of FIGS. 12(a) and (b) shows the charged Ni content (mol %) of the exhaust gas purification catalyst on the abscissa, and shows the NO 50% purification temperature T50 (° C.) on the ordinate.

Referring to FIGS. 12(a) and (b), under both reaction conditions, the exhaust gas purification catalysts of Examples 1 to 4 showed a low NO 50% purification temperature T50, compared with the exhaust gas purification catalysts of Comparative Examples 3 to 5 prepared by the conventional impregnation method, Comparative Example 1 using CeO₂ alone, and Comparative Example 2 using NiO alone, and therefore were able to achieve a high NO reduction activity. Above all, under the presence of oxygen, high NO reduction activity was obtained in the exhaust gas purification catalysts (charged Ni content: 10 and 20 mol %) of Examples 1 and 2, and in the case where oxygen was not present, high NO reduction activity was obtained in the exhaust gas purification catalysts (charged Ni content: 10, 20 and 40 mol %) of Examples 1 to 3. These results suggest that in an exhaust gas purification catalyst having a charged Ni content of 10 to 20 mol % (corresponding to 9 to 22 mol % of the found value by ICP emission analysis), an active site contributing to NO reduction reaction specifically exists even in the presence of oxygen.

On the other hand, in the exhaust gas purification catalysts of Comparative Examples 3 to 5 prepared by the conventional impregnation method, T50 was high at all Ni contents and the values thereof had little difference. As a result, sufficient NO reduction activity was not able to be obtained. In the exhaust gas purification catalyst (charged Ni content: 10 mol %) of Comparative Example 6 prepared by the conventional coprecipitation method, T50 was 493° C. in the presence of oxygen and 473° C. in the absence of oxygen, and therefore the NO reduction activity was very low, compared with the exhaust gas purification catalyst of Example 1 having the same composition. In addition, although not shown in FIG. 12, in the exhaust gas purification catalyst (charged Ni content: 40 mol %) of Comparative Example 7 prepared by the conventional coprecipitation method, T50 was 600° C. or more under both conditions where oxygen was present and where oxygen was not present, and therefore the NO reduction activity was very low.

Next, with respect to the exhaust gas purification catalysts of Example 1, Comparative Example 3 (impregnation method) and Comparative Example 6 (coprecipitation method), the change in the NO purification ratio when lowering the temperature of the catalyst bed from 600° C. to 100° C. at a rate of 20° C./min was examined using oxygen-containing model gas 2 for evaluation. FIG. 13 shows the results obtained.

FIG. 13 shows the NO purification ratio regarding the exhaust gas purification catalysts of Example 1, Comparative Example 3 (impregnation method) and Comparative Example 6 (coprecipitation method) when oxygen is present. FIG. 13 shows the temperature (° C.) of the catalyst bed on the abscissa, and shows the NO purification ratio (%) on the ordinate. Referring to FIG. 13, it is seen that even in the presence of oxygen, the exhaust gas purification catalyst prepared by the method of the present invention not only can maintain high NOx reduction activity in a high temperature region, but also can achieve very high NOx reduction activity in a low temperature region of, for example, 300° C. or less, compared with the exhaust gas purification catalyst prepared by the conventional impregnation method or coprecipitation method.

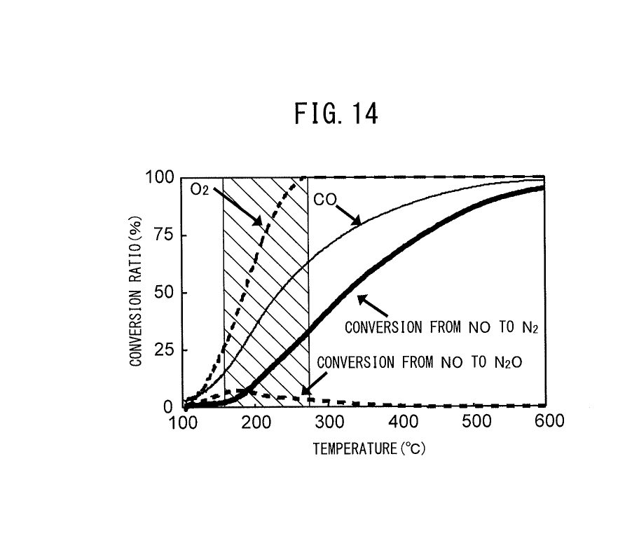

Next, with respect to the exhaust gas purification catalyst of Example 2, the conversion profiles of NO, CO and O₂ when lowering the temperature of the catalyst bed from 600° C. to 100° C. at a rate of 20° C./min were examined using oxygen-containing model gas 2 for evaluation. FIG. 14 shows the results obtained. Referring to FIG. 14, it is seen that when the exhaust gas purification catalyst of the present invention was used, a reduction reaction from NO to N₂ proceeded even in a low temperature region of less than about 270° C. where oxygen in the gas phase was not completely consumed, and therefore oxygen remained in the gas phase. In addition, in this temperature region, conversion from NO to N₂O was slightly recognized. Accordingly, it is believed that in the above temperature region, in addition to the reaction of formula (1), a reaction of following formula (2) proceeded.

2NO+CO→N₂O+CO₂ (2)

[Surface Analysis of Catalyst by X-Ray Photoelectron Spectroscopy (XPS)]

The exhaust gas purification catalysts of Examples 1 to 3 and Comparative Examples 1 and 2 were measured using an X-ray photoelectron spectroscopy (XPS) apparatus (XPS1600, manufactured by Ulvac-Phi, Inc.). Here, MgKα (1253.6 eV) was used for the X-ray source, and each catalyst powder was placed under reduced pressure of 10⁻⁷ Pa and analyzed with a binding energy error of ±0.2 eV by using C1s (E_{b}=284.6 eV) as the reference peak. In addition, the surface composition ratio of Ni and Ce was examined by peak separation. The surface composition ratio of Ni, Ce and O calculated by XPS, and the bulk composition ratio of Ni, Ce and O calculated by ICP analysis are shown in Table 4. Referring to Table 4, the surface Ni ratio showed a low value compared with the bulk Ni ratio, but in the exhaust gas purification catalysts of Examples 1 to 3, the surface composition ratio substantially agreed with the bulk composition ratio.

TABLE 4
Surface Composition Ratio and Bulk Composition
Ratio of Examples 1 to 3 and Comparative Examples 1 and 2

| | | Surface Composition | | | Bulk Composition | | |
|---|---|---|---|---|---|---|---|
| | | Ratio (atomic %) | | | Ratio (atomic %) | | |
| | | O | Ni | Ce | O | Ni | Ce |
| Comparative | CeO₂ | 72.7 | 0 | 27.3 | — | — | — |
| Example 1 | | | | | | | |
| Example 1 | Ni1Ce₉ | 73.7 | 0.8 | 25.6 | 73.2 | 2.5 | 24.3 |
| Example 2 | Ni2Ce₈ | 71.6 | 3.7 | 24.7 | 71.7 | 6.3 | 22.0 |
| Example 3 | Ni4Ce₆ | 70.0 | 7.2 | 22.9 | 66.9 | 13.9 | 19.1 |
| Comparative | NiO | 64.7 | 35.3 | 0 | — | — | — |
| Example 2 | | | | | | | |

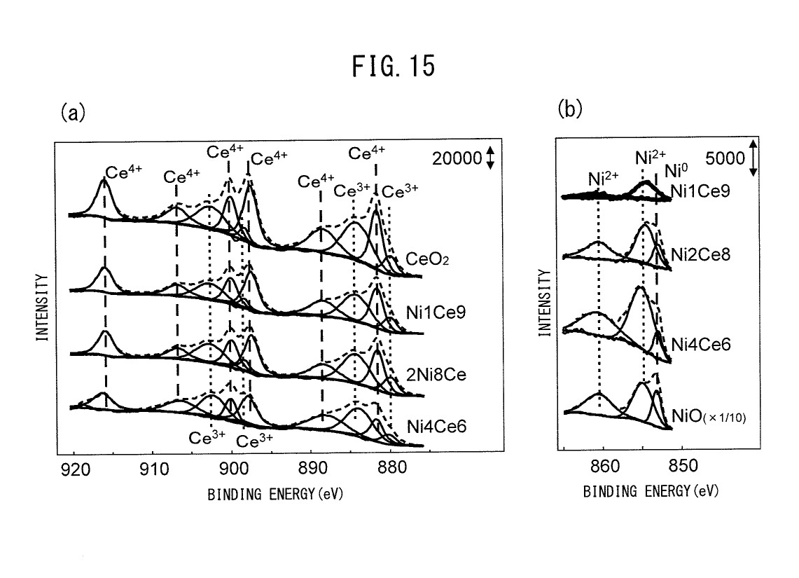

FIG. 15 shows X-ray photoelectron spectroscopy (XPS) analysis results of the exhaust gas purification catalysts of Examples 1 to 3 and Comparative Examples 1 and 2. FIG. 15(a) shows the spectrum of Ce3d region, and FIG. 15(b) shows the spectrum of Ni2p region. In the spectrum of Ce3d region, the region of 900 to 900 eV is derived from Ce3d_{3/2}, and the region of 870 to 900 eV is derived from Ce3d_{5/2}.

Referring to FIG. 15(a), as a result of peak separation, it is seen that both Ce³⁺ and Ce⁴⁺ were detected in the exhaust gas purification catalysts of Examples 1 to 3 and Comparative Example 1, and Ce⁴⁺ is the major abundance species. On the other hand, referring to FIG. 15(b), Ni is also present in a plurality of chemical states, and from the results of waveform separation, these were found to be Ni²⁺ and Ni⁰. Next, the oxidation number ratios of surface elements, specifically the ratio of Ce³⁺ in all Ce and the ratio of Ni²⁺ in all Ni in the exhaust gas purification catalysts of Examples 1 to 3 and Comparative Examples 1 and 2 were calculated from the XPS analysis results. The results obtained are shown in Table 5.

TABLE 5
Oxidation Number Ratios of Surface Elements of
Examples 1 to 3 and Comparative Examples 1 and 2

| | | Ce³⁺/(Ce⁴⁺ + Ce³⁺) | Ni²⁺/(Ni²⁺ + Ni⁰) |
|---|---|---|---|
| | | (atomic %) | (atomic %) |
| Comparative | CeO₂ | 33 | 0 |
| Example 1 | | | |
| Example 1 | Ni1Ce9 | 37 | 98 |
| Example 2 | Ni2Ce8 | 41 | 72 |
| Example 3 | Ni4Ce6 | 41 | 87 |
| Comparative | NiO | — | 59 |
| Example 2 | | | |

Referring to Table 5, while 33 atomic % of Ce³⁺ was present in the exhaust gas purification catalyst (CeO₂) of Comparative Example 1 not containing Ni, the ratio of Ce³⁺ was increased as the Ni content increases, and it converged to 41 atomic % in the exhaust gas purification catalyst (Ni2Ce8) of Example 2. This is believed to be due to the fact that compositing CeO₂ and NiO allowed formation of an oxygen hole at the interface therebetween or oxygen in CeO₂ was caused to readily escape by compositing CeO₂ and NiO, as a result, Ce⁴⁺ became susceptible to reduction under reduced pressure at the time of XPS analysis. On the other hand, as to the oxidation number ratio of surface Ni, a clear regularity was not recognized. However, it is believed from the results of FIG. 15(b) and Table 5 that in each exhaust gas purification catalyst, part of NiO surface was reduced under reduced pressure to produce Ni metal.

### [Analysis of Catalyst by Raman Scattering]

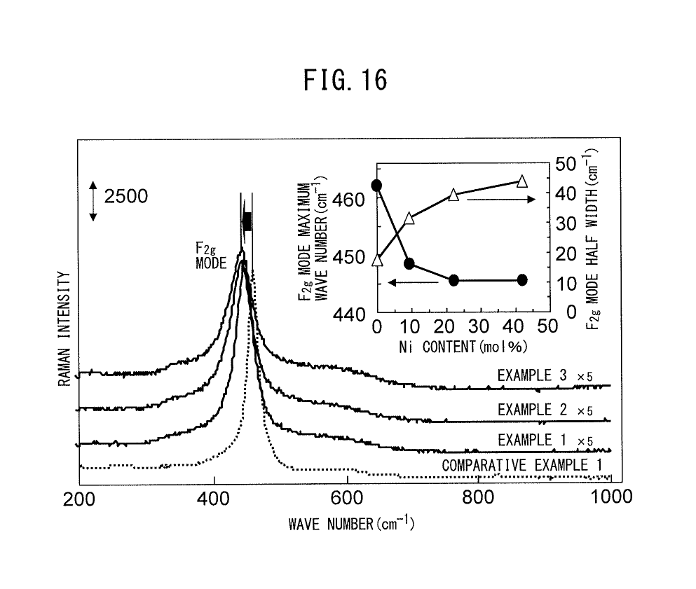

The exhaust gas purification catalysts of Examples 1 to 3 and Comparative Example 1 were measured using a microscopic laser Raman spectrometer, Nanofinder 30, manufactured by Tokyo Instruments Inc. Here, an excitation laser of 488 nm was used in the measurement, and the catalyst was analyzed with a spot size of about 1 mm and a resolution of 1 cm⁻¹. FIG. 16 shows the results obtained.

FIG. 16 shows Raman spectroscopy analysis results of the exhaust gas purification catalysts of Examples 1 to 3 and Comparative Example 1. Here, the Raman spectroscopy is frequently used for the characterization of a CeO₂-based oxide, and it is generally known that a triple-degenerated F_{2g} vibration mode in Ce—O bond in the CeO₂ fluorite structure (see FIG. 5) is detected around 460 cm⁻¹. In addition, the intensity at the Raman shift detected and the analytical depth generally depend on the wavelength of the excitation laser. The laser wavelength employed this time is 488 nm, and therefore a Raman shift in the surface portion is detected in a highlighted manner.

FIG. 16 shows the spectra obtained by Raman spectroscopy and the results when the peak shift and half width relative to the charged Ni content are plotted. Referring to FIG. 16, the Fe_{2g} vibration mode around 460 cm⁻¹ was shifted to the low wave number side while broadening along with the increase of Ni content and converged at an Ni content of 20 mol % (Example 2: Ni2Ce8). Since the wave number has a relationship with the binding energy of Ce—O, the peak shift to the low wave number side indicates that the Ce—O bond is weakened. In addition, the broadening of the peak indicates the presence of a plurality of kinds of Ce—O bond. Accordingly, it is recognized from the Raman spectroscopy analysis results that the CeO₂ fluorite structure is disturbed by compositing CeO₂ and NiO to allow the existence of a portion where the Ce—O bond is weakened.

### [Structural Analysis of Catalyst by XAFS]

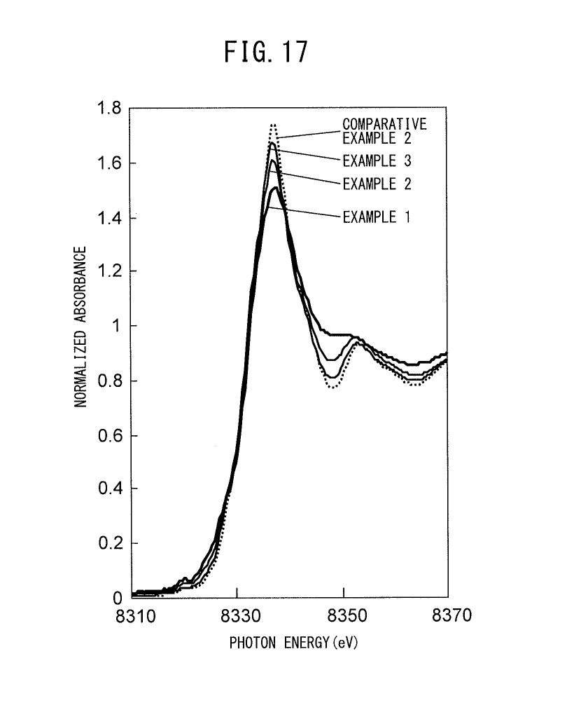

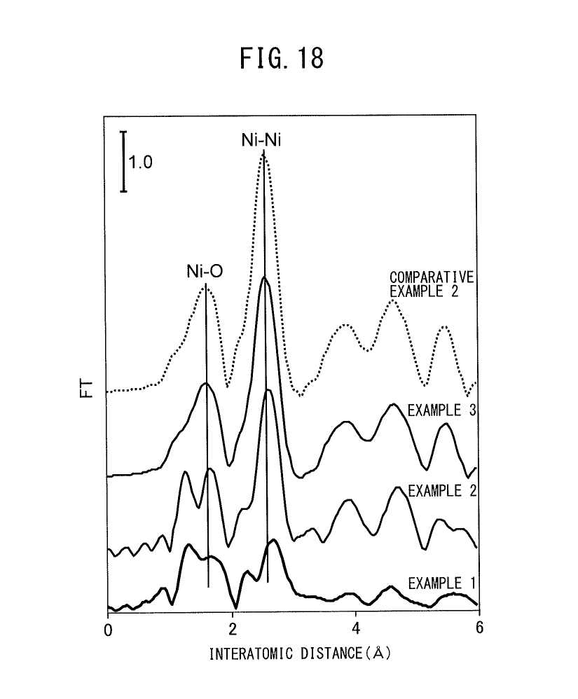

With respect to the exhaust gas purification catalysts of Examples 1 to 3 and Comparative Example 2, X-ray absorption fine structure (XAFS) analysis was performed. Here, the XAFS spectrum at Ni—K absorption edge was measured by using, as the reference, the spectra of Ni foil and NiO powder. The experiment was carried out in BL33XU (Toyota BL) of Spring 8. FIGS. 17 and 18 show the results obtained.

FIG. 17 shows an XANES spectrum at Ni—K absorption edge regarding the exhaust gas purification catalysts of Examples 1 to 3 and Comparative Example 2. Referring to FIG. 17, there was observed a tendency that the spectrum shape is varied from the spectrum shape of Comparative Example 2 (NiO) as the Ni content in the catalyst decreases. This suggests that in the catalyst having a small Ni content, many Ni species having electron states different from bulk NiO are present.

FIG. 18 shows a radial distribution function obtained by Fourier transforming the EXAFS spectrum at Ni—K absorption edge regarding the exhaust gas purification catalysts of Examples 1 to 3 and Comparative Example 2. Referring to FIG. 18, in the exhaust gas purification catalysts of Examples 1 and 2, the peak attributable to Ni—O near an interatomic distance of 1.8 Å is split, and therefore disturbance of the peripheral structure of Ni was confirmed. In addition, there was observed a tendency that as the Ni content in the catalyst decreases, the ratio of the peak intensity attributable to Ni—Ni near an interatomic distance of 2.6 Å to the peak intensity attributable to Ni—O near an interatomic distance of 1.8 Å decreases. The ratio of these peak intensities regarding each exhaust gas purification catalyst is shown in Table 6.

TABLE 6
Intensity Ratio of Ni—O Peak to Ni—Ni Peak of
Each Catalyst

| | | Ni—O:Ni—Ni |
|---|---|---|
| Example 1 | Ni1Ce9 | 1:1.06 |
| Example 2 | Ni2Ce8 | 1:1.86 |
| Example 3 | Ni4Ce6 | 1:2.06 |
| Comparative | NiO | 1:2.18 |
| Example 2 | | |

Such a tendency is particularly prominent in the exhaust gas purification catalysts of Examples 1 and 2. The intensity of the peak attributable to Ni—Ni near 2.6 Å corresponds to the number of Ni atoms adjoining one Ni atom. Accordingly, these results suggest that when NiO and CeO₂ are composited, an Ni species different from bulk NiO of a so-called NaCl structure (FIG. 3) exists. In addition, the exhaust gas purification catalysts of Examples 1 to 3 were not significantly different as to the interatomic distance of Ni—Ni of 2.6 Å from the exhaust gas purification catalyst of Comparative Example 2. It is believed from these facts that the number of Ni species substituted for Ce⁴⁺ in CeO₂ having a fluorite structure is very small.

### [In-Situ XAFS Analysis]

With respect to the exhaust gas purification catalysts of Example 1 and Comparative Examples 1 to 3, in-situ XAFS analysis was performed. This analysis used a pellet obtained by mixing a powder of each of these exhaust gas purification catalysts and boron nitride in a mortar, putting a predetermined amount of the mixture in a molding vessel having a diameter of 7 mm, and compression-molding it at 10 MPa for 1 minute.

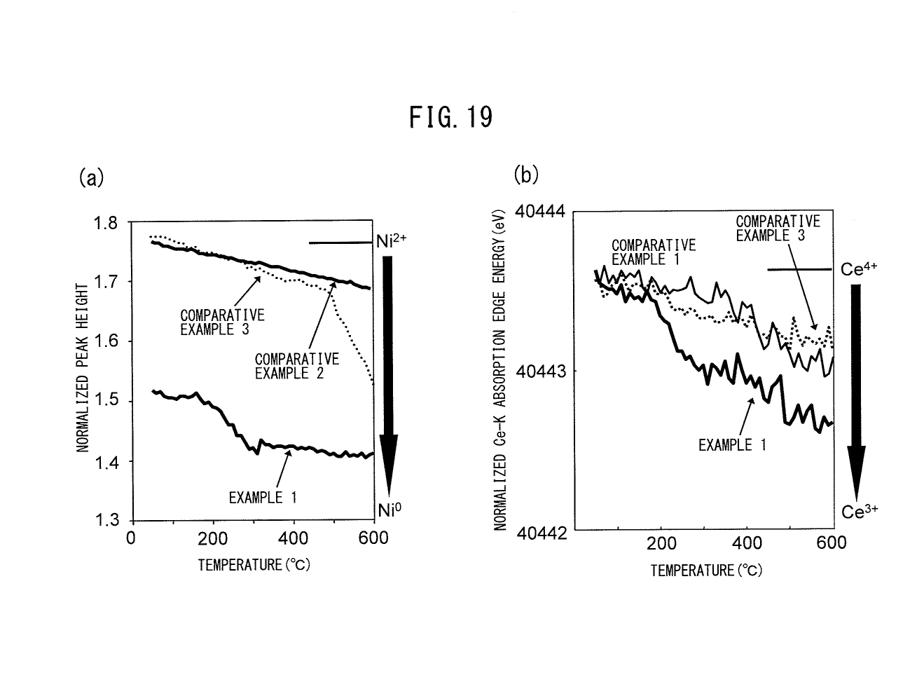

Model gas 3 for evaluation (NO: 4,000 ppm, CO: 8,000 ppm, O₂: 2,000 ppm, He balance) was flowed on the above pellet at a flow rate of 100 cc/min, and the Ni—K absorption end and Ce—K absorption end were measured for XAFS by elevating and lowering the temperature at 20° C./min in the temperature region of 50 to 600° C. Each spectrum was measured at intervals of once/10° C. In the analysis of spectrum, XAFS view ver. 3 was used, and the spectra of Ni foil and NiO powder were used as the reference. In the analysis of Ce spectrum, the absorption end energy was corrected using a function of Auto Energy Correction. The experiment was carried out in BL33XU (Toyota BL) of Spring 8. FIG. 19 shows the results.

FIGS. 19(a) and (b) show the change in the spectra of Ni and Ce during reaction under the above-described reaction conditions. Referring to FIG. 19(a), NiO was gradually reduced until 500° C. in the exhaust gas purification catalysts of Comparative Example 2 (NiO) and Comparative Example 3 (NiO/CeO₂) produced by impregnation method, whereas the existence of NiO that is reduced from about 200° C. was found in the exhaust gas purification catalyst of Example 1 (Ni1Ce9). Referring to FIG. 19(b), similarly, the existence of CeO₂ that is reduced from about 200° C. was found in the exhaust gas purification catalyst of Example 1 (Ni1Ce9). These reduction starting temperatures agree with the temperature at which purification of NO is started (FIGS. 13 and 14). These results suggest that the existence of NiO species having a strong interaction with CeO₂ and relatively easily reduced contributes to the NOx purification reaction.

### DESCRIPTION OF REFERENCE NUMERALS

1: Primary particle
2: CeO₂
3: NiO Cluster
4: Oxygen hole
10: Exhaust gas purification catalyst

1. An exhaust gas purification catalyst, comprising a nanocomposite material comprising ceria and nickel oxide, wherein the ceria and nickel oxide are uniformly mixed, and wherein the uniform mixing satisfies at least one of following conditions (a) and (b):
(a) when the nanocomposite material is analyzed using a scanning transmission electron microscope equipped with an energy dispersive X-ray analyzer (STEM-EDX) under condition in which the spot size of an electron beam is 1 nm or less, the number of nickel atoms is from 3 to 20 atomic % relative to the total number of nickel and cerium atoms at a majority of randomly selected 5 or more measurement points in which both cerium and nickel elements are detected, and
(b) in the Fourier transform of Extended X-ray Absorption Fine Structure (EXAFS) spectrum at Ni—K absorption edge regarding the nanocomposite material, the ratio of the intensity of a peak attributable to Ni—O near an interatomic distance of 1.8 Å to the intensity of a peak attributable to Ni—Ni near an interatomic distance of 2.6 Å is 1:at least 0.50 to less than 2.18.

2. The exhaust gas purification catalyst as claimed in claim 1, wherein the uniform mixing at least satisfies the condition (a).

3. The exhaust gas purification catalyst as claimed in claim 1, wherein the uniform mixing at least satisfies the condition (b).

4. The exhaust gas purification catalyst as claimed in claim 1, wherein in the condition (a), the number of nickel atoms is from 3 to 20 atomic % relative to the total number of nickel and cerium atoms at 70% or more of randomly selected 5 or more measurement points in which both cerium and nickel elements are detected.

5. The exhaust gas purification catalyst as claimed in claim 1, wherein the number of nickel atoms is from 5 to 15 atomic % relative to the total number of nickel and cerium atoms.

6. The exhaust gas purification catalyst as claimed in claim 1, wherein in the condition (b), the intensity ratio of the peaks is 1:at least 1.00 to no more than 2.10.

7. The exhaust gas purification catalyst as claimed in claim 1, wherein in the X-ray diffraction with CuKα ray of the nanocomposite material, the height of the diffraction peak around 43.3° attributable to NiO is less than or equal to one-tenth of the height of the diffraction peak around 28.5° attributable to CeO2.

8. The exhaust gas purification catalyst as claimed in claim 7, wherein in the X-ray diffraction with CuKα ray of the nanocomposite material, the diffraction peak around 43.3° attributable to NiO is not observed.

9. The exhaust gas purification catalyst as claimed in claim 1, wherein the nanocomposite material has a nickel content of greater than 0 mol % to no more than 80 mol % relative to all metal elements contained in the nanocomposite material.

10. The exhaust gas purification catalyst as claimed in claim 9, wherein the nanocomposite material has a nickel content of at least 9 mol % to no more than 42 mol % relative to all metal elements contained in the nanocomposite material.

11. The exhaust gas purification catalyst as claimed in claim 1, wherein the ceria has a crystallite size of greater than 0 nm to no more than 10 nm.

12. The exhaust gas purification catalyst as claimed in claim 1, wherein the nanocomposite material has a specific surface area of 90 m²/g or more.

13. A method for producing an exhaust gas purification catalyst, comprising:
introducing a basic substance into an aqueous solution containing cerium ions, nickel ions and a surfactant,
hydrothermally treating the resulting mixed solution to form a nanocomposite material precursor, and
drying and firing the nanocomposite material precursor.

14. The method as claimed in claim 13, wherein the hydrothermal treating step is carried out at a temperature of 100 to 150° C.

15. The method as claimed in claim 13, wherein the surfactant is selected from the group consisting of an anionic surfactant, a cationic surfactant, an amphoteric surfactant, a nonionic surfactant, and combinations thereof.

16. The method as claimed in claim 13, wherein the surfactant is cetyltrimethylammonium bromide.

17. The method as claimed in claim 13, wherein the basic substance is selected from the group consisting of sodium hydroxide, potassium hydroxide, ammonia, sodium carbonate, and combinations thereof.
